(19) United States
(12) Patent Application Publication
(10) Pub. No.: US 2011/0265455 A1
(43) Pub. Date: Nov. 3, 2011

(54) AMMONIA BURNING INTERNAL COMBUSTION ENGINE

(75) Inventors: Shinya HIROTA, Susono-shi (JP); Tsuyoshi Ashida, Numadu-shi (JP); Ryo Michikawauchi, Susono-shi (JP); Yasushi Ito, Susono-shi (JP); Shiro Tanno, Gotemba-shi (JP)

(73) Assignee: TOYOTA JIDOSHA KABUSHIKI KAISHA, Toyota-shi (JP)

(21) Appl. No.: 12/769,257

(22) Filed: Apr. 28, 2010

(51) Int. Cl. F02D 41/30

(52) U.S. Cl. 60/285

(57) ABSTRACT

An ammonia burning internal combustion engine capable of using ammonia as fuel comprises an exhaust purifying catalyst purifying ammonia and NOₓ in an inflowing exhaust gas and an inflowing gas control system controlling a ratio of ammonia and NOₓ in the exhaust gas flowing into the exhaust purifying catalyst. The inflowing gas control system controls control parameters of the internal combustion engine so that the ratio of the ammonia and NOₓ in the exhaust gas flowing into the exhaust purifying catalyst becomes a target ratio. As a result, an internal combustion engine capable of purifying unburned ammonia and NOₓ in an exhaust gas well by a post-treatment system is provided.

### BACKGROUND OF THE INVENTION

1. Field of the Invention

The present invention relates to an ammonia burning internal combustion engine.

2. Description of the Related Art

In an internal combustion engine, in the past, the fuel used has mainly been fossil fuels. However, in this case, burning such fuels produces CO₂, which causes global warming. On the other hand, burning ammonia does not produce CO₂ at all. Thus, there is known an internal combustion engine made so as to use ammonia as fuel and not produce CO₂ (for example, see the following prior art).

As prior art, there is Japanese Patent Publication (A) No. 5-332152).

### SUMMARY OF THE INVENTION

In this regard, in an internal combustion engine using ammonia as fuel, there is possibility that a portion of the ammonia fed into a combustion chamber will be discharged from the combustion chamber without being burned in the combustion chamber. Further, in the same way as an internal combustion engine using fossil fuel, in an internal combustion engine using ammonia as fuel as well, there is possibility that NOₓ will be generated along with burning of the air-fuel mixture in a combustion chamber. For this reason, in such internal combustion engines, it is necessary to efficiently purify unburned ammonia and NOₓ contained in exhaust gas exhausted from a combustion chamber by a post-treatment system. In the internal combustion engine disclosed in Japanese Patent Publication (A) No. 5-332152, however, no countermeasure is taken for purifying ammonia and NOₓ.

Therefore, an object of the present invention is to enable purifying of unburned ammonia and NOₓ in exhaust gas well by a post-treatment system in an ammonia burning internal combustion engine capable of being fed ammonia as fuel.

In order to solve the above problem, in a first aspect of the invention, there is provided an ammonia burning internal combustion engine capable of using ammonia as fuel, provided with an exhaust purifying catalyst purifying ammonia and NOₓ in inflowing exhaust gas and an inflowing gas control system controlling a ratio of ammonia and NOₓ in the exhaust gas flowing into the exhaust purifying catalyst, wherein the inflowing gas control system controls control parameters of the internal combustion engine so that the ratio of the ammonia and NOₓ in the exhaust gas flowing into the exhaust purifying catalyst becomes a target ratio.

In a second aspect of the invention, there is provided the first aspect of the invention in which the target ratio is made a ratio by which NOₓ in the exhaust gas flowing into the exhaust purifying catalyst is purified exactly enough by ammonia in the exhaust gas.

In a third aspect of the invention, there is provided the first aspect of the invention in which the exhaust purifying catalyst is an NOₓ selective reduction catalyst able to selectively reduce NOₓ in the exhaust gas by adsorbed ammonia, and the target ratio is made a ratio by which the NOₓ becomes larger than a ratio by which NOₓ in the exhaust gas flowing into the NOₓ selective reduction catalyst is purified exactly enough by ammonia in the exhaust gas.

In a fourth aspect of the invention, there is provided the third aspect of the invention in which the target ratio is made a ratio by which a sum of a maximum amount of ammonia which can be disassociated from the NOₓ selective reduction catalyst per unit time and a flow rate of ammonia in the exhaust gas flowing into the NOₓ selective reduction catalyst becomes smaller than an amount by which exactly enough purifying is carried out by NOₓ in the exhaust gas flowing into the NOₓ selective reduction catalyst.

In a fifth aspect of the invention, there is provided the first aspect of the invention in which the inflowing gas control system can control the flow rate of NOₓ flowing into the exhaust purifying catalyst, and the flow rate of NOₓ flowing into the exhaust purifying catalyst is controlled to become a flow rate not more than a maximum amount of NOₓ which can be purified per unit time in the exhaust purifying catalyst.

In a sixth aspect of the invention, there is provided the first aspect of the invention in which a maximum amount of NOₓ which can be purified per unit time in the exhaust purifying catalyst changes in accordance with a temperature of the exhaust purifying catalyst, and the temperature of the exhaust purifying catalyst is controlled so that the flow rate of NOₓ flowing into the exhaust purifying catalyst becomes a flow rate not more than the maximum amount of NOₓ which can be purified per unit time in the exhaust purifying catalyst.

In a seventh aspect of the invention, there is provided the third aspect of the invention in which when an amount of ammonia adsorbed at the NOₓ selective reduction catalyst becomes smaller than a minimum reference amount, the target ratio is controlled to a ratio by which ammonia becomes larger than a ratio by which NOₓ in the exhaust gas flowing into the NOₓ selective reduction catalyst is purified exactly enough by ammonia in the exhaust gas.

In an eighth aspect of the invention, there is provided the first aspect of the invention in which the exhaust purifying catalyst is an NOₓ selective reduction catalyst which can selectively reduce NOₓ in the exhaust gas by the adsorbed ammonia, and the target ratio is made a ratio by which ammonia becomes larger than a ratio by which NOₓ in the exhaust gas flowing into the NOₓ selective reduction catalyst is purified exactly enough by ammonia in the exhaust gas.

In a ninth aspect of the invention, there is provided the seventh or eighth aspect of the invention in which when an amount of ammonia adsorbed at the NOₓ selective reduction catalyst becomes larger than a maximum allowable adsorption amount, the target ratio is changed so that the ratio of ammonia in the exhaust gas flowing into the NOₓ selective reduction catalyst becomes lower.

In a 10th aspect of the invention, there is provided the first aspect of the invention in which the exhaust purifying catalyst is an NOₓ storage reduction catalyst storing NOₓ in the exhaust gas when an air-fuel ratio of the inflowing exhaust gas is lean and making the stored NOₓ disassociate when an oxygen concentration of the inflowing exhaust gas becomes low, and the target ratio is made a ratio by which NOₓ becomes larger than a ratio by which NOₓ in the exhaust gas flowing into the exhaust purifying catalyst is purified exactly enough by ammonia in the exhaust gas.

In an 11th aspect of the invention, there is provided the 10th aspect of the invention in which when the amount of NOₓ stored in the NOₓ storage reduction catalyst becomes larger than a maximum allowable storage amount, the target ratio is controlled to a ratio by which ammonia becomes larger than a ratio by which NOₓ in the exhaust gas flowing into the NOₓ storage reduction catalyst is purified exactly enough by ammonia in the exhaust gas.

In a 12th aspect of the invention, there is provided the first aspect of the invention in which the inflowing gas control system advances an ignition timing or igniting timing of the air-fuel mixture in a combustion chamber when lowering the ratio of ammonia in the exhaust gas flowing into the exhaust purifying catalyst.

In a 13th aspect of the invention, there is provided the first aspect of the invention in which the inflowing gas control system lowers the air-fuel ratio of the air-fuel mixture fed into the combustion chamber when raising the ratio of ammonia in the exhaust gas flowing into the exhaust purifying catalyst.

In a 14th aspect of the invention, there is provided the first aspect of the invention in which the engine is further provided with an ammonia injector directly injecting ammonia into a combustion chamber, and the inflowing gas control system makes the ammonia injector inject ammonia in an expansion stroke or an exhaust stroke when the ratio of ammonia in the exhaust gas flowing into the exhaust purifying catalyst is made higher.

In a 15th aspect of the invention, there is provided the ammonia burning internal combustion engine of the first aspect of the invention in which fuel other than ammonia can be used in addition to ammonia, and the inflowing gas control system lowers the ratio of ammonia in the ammonia and fuel other than ammonia which are fed into the combustion chamber when lowering the ratio of ammonia in the exhaust gas flowing into the exhaust purifying catalyst.

In a 16th aspect of the invention, there is provided the first aspect of the invention in which the engine is further provided with a non-ammonia fuel injector capable of directly feeding fuel other than ammonia into a combustion chamber, and the inflowing gas control system makes the non-ammonia fuel injector inject fuel other than ammonia into the combustion chamber in the expansion stroke of the internal combustion engine when lowering the ratio of ammonia in the exhaust gas flowing into the exhaust purifying catalyst.

In a 17th aspect of the invention, there is provided the first aspect of the invention in which the engine is further provided with an oxidation catalyst provided at an upstream side of the exhaust purifying catalyst.

In an 18th aspect of the invention, there is provided the 17th aspect of the invention in which the inflowing gas control system is further provided with a bypass passage for bypassing the oxidation catalyst and a flow rate control valve controlling the flow rate of the exhaust gas flowing into the bypass passage, wherein the flow rate control valve is controlled so that the ratio of ammonia and NOₓ in the exhaust gas flowing into the exhaust purifying catalyst becomes the target ratio.

In a 19th aspect of the invention, there is provided the 18th aspect of the invention in which the inflowing gas control system increases the flow rate of the exhaust gas flowing into the bypass passage when raising the ratio of ammonia in the exhaust gas flowing into the exhaust purifying catalyst.

In a 20th aspect of the invention, there is provided the 17th aspect of the invention in which the inflowing gas control system is further provided with a bypass passage for bypassing the oxidation catalyst and a flow rate control valve controlling the flow rate of the exhaust gas flowing into the bypass passage, wherein the flow rate control valve is controlled so that all exhaust gas flows into the bypass passage when the flow rate of NOₓ in the exhaust gas flowing out of the combustion chamber is larger than the maximum amount of NOₓ which can be purified per unit time.

In a 21st aspect of the invention, there is provided the first aspect of the invention in which the ammonia burning internal combustion engine is provided with a plurality of cylinders, wherein the air-fuel ratio of the air-fuel mixture is made rich in part of the cylinders among these plurality of cylinders, the air-fuel ratio of the air-fuel mixture is made lean in the other cylinders, and the inflowing gas control system controls a degree of richness and a degree of leanness of these cylinders so that the ratio of ammonia and NOₓ in the exhaust gas flowing into the exhaust purifying catalyst becomes the target ratio.

In a 22nd aspect of the invention, there is provided the first aspect of the invention in which the engine is further provided with an ammonia addition device adding ammonia into the exhaust gas flowing into the exhaust purifying catalyst, and the inflowing gas control system increases the added amount of ammonia from the ammonia addition device when raising the ratio of ammonia in the exhaust gas flowing into the exhaust purifying catalyst.

In a 23rd aspect of the invention, there is provided the 22n aspect of the invention in which the ammonia addition device can add liquid ammonia and gaseous ammonia into the exhaust gas, and liquid ammonia is added into the exhaust gas when the temperature of the exhaust purifying catalyst should be lowered.

In a 24th aspect of the invention, there is provided the first aspect of the invention in which the internal combustion engine is controlled so that the air-fuel ratio of the air-fuel mixture becomes rich or lean at the time of normal running and controlled so that the air-fuel ratio of the air-fuel mixture becomes substantially the stoichiometric air-fuel ratio when a purifying capability with respect to ammonia and NOₓ of the exhaust purifying catalyst is lower than a predetermined purifying capability.

In a 25th aspect of the invention, there is provided the first aspect of the invention in which a fuel other than ammonia can be used in addition to ammonia, and the ratio of ammonia in the ammonia and the fuel other than ammonia which are fed into the combustion chamber is made low at the time when the purifying capability with respect to ammonia and NOₓ of the exhaust purifying catalyst is lower than a predetermined purifying capability in comparison with the time when the former is higher than the predetermined purifying capability.

In a 26th aspect of the invention, there is provided the first aspect of the invention in which the engine is further provided with a non-ammonia fuel injector capable of directly injecting fuel other than ammonia into the combustion chamber, wherein the fuel other than ammonia is injected from the non-ammonia fuel injector into the combustion chamber in the expansion stroke of the internal combustion engine when the purifying capability with respect to ammonia and NOₓ of the exhaust purifying catalyst is lower than the predetermined purifying capability.

In a 27th aspect of the invention, there is provided the first aspect of the invention in which the engine is further provided with an electric heater heating the exhaust purifying catalyst, and the exhaust purifying catalyst is heated by the electric heater when the temperature of the exhaust purifying catalyst is lower than an activation temperature.

In a 28th aspect of the invention, there is provided the 27th aspect of the invention in which a vehicle mounting the ammonia burning internal combustion engine is a hybrid vehicle driven by the ammonia burning internal combustion engine and a motor, and the exhaust purifying catalyst is heated by the electric heater and the vehicle is run by the motor when the temperature of the exhaust purifying catalyst is lower than the activation temperature.

In a 29th aspect of the invention, there is provided the first aspect of the invention in which the engine is further provided with a bypass passage branched from an engine exhaust passage, an ammonia adsorbent provided in the bypass passage, and a flow rate control valve controlling the flow rate of the exhaust gas flowing into the engine exhaust passage and the bypass passage, wherein the flow rate control valve is controlled so that the exhaust gas exhausted from the engine body flows into the bypass passage at the time of cold start of the internal combustion engine.

In a 30th aspect of the invention, there is provided the 29th aspect of the invention in which the flow rate control valve is controlled so that a portion of the exhaust gas exhausted from the engine body flows into the bypass passage after the temperature of the exhaust purifying catalyst becomes the activation temperature or more, and the flow rate control valve is controlled so that all of the exhaust gas exhausted from the engine body does not flow into the bypass passage, but flows through the engine exhaust passage after the amount of ammonia adsorbed at the ammonia adsorbent is reduced to a constant amount or less.

In a 31st aspect of the invention, there is provided the first aspect of the invention in which the engine is further provided with a holder for holding condensation condensed from water vapor contained in the exhaust gas in the engine exhaust passage, and the holder is arranged so that the condensation held in the holder is exposed to the exhaust gas.

In a 32nd aspect of the invention, there is provided the 31st aspect of the invention in which the engine is further provided with a condensation feed passage for connecting the holder and an engine intake passage, and the condensation in the holder is fed into the engine intake passage through the condensation feed passage.

In a 33rd aspect of the invention, there is provided the first aspect of the invention in which the engine is further provided with an NOₓ sensor having an output value becoming larger when the NOₓ and ammonia in the exhaust gas flowing in the engine exhaust passage increase, control parameters of the internal combustion engine are controlled so that ammonia or NOₓ in the exhaust gas flowing in the engine exhaust passage increases when detecting the flow rate of NOₓ by the NOₓ sensor, and an ingredient detected by the NOₓ sensor is discriminated based on a change of the output value of the NOₓ sensor along with the increase of this ammonia.

In a 34th aspect of the invention, there is provided the first aspect of the invention in which the engine is further provided with an NOₓ detector detecting the concentration of NOₓ in the exhaust gas exhausted from the exhaust purifying catalyst and an ammonia detector detecting the concentration of ammonia in the exhaust gas exhausted from the exhaust purifying catalyst at a downstream side of the exhaust purifying catalyst.

Summarizing the advantageous effects, according to the present invention, there is provided an ammonia burning internal combustion engine capable of using ammonia as fuel in which unburned ammonia and NOₓ in the exhaust gas can be purified well by a post-treatment system.

### BRIEF DESCRIPTION OF THE DRAWINGS

These and other objects and features of the present invention will become clearer from the following description of the preferred embodiments given with reference to the attached drawings, wherein:

FIG. 1 is an overall view of an internal combustion engine of a first embodiment;

FIG. 2 is an overall view of another example of the internal combustion engine of the first embodiment;

FIG. 3 is an overall view of still another example of the internal combustion engine of the first embodiment;

FIG. 4 is a diagram showing a relationship between a temperature of an exhaust purifying catalyst and a maximum purifiable NOₓ amount;

FIG. 5 is a flowchart showing a control routine of inflow ratio control for controlling the ratio of NOₓ and unburned ammonia flowing into the exhaust purifying catalyst;

FIG. 6 is a flowchart showing a control routine of inflow ratio control in a case where use is made of one NOₓ sensor reacting to both of NOₓ and ammonia;

FIG. 7 is an overall view of an internal combustion engine of a second embodiment;

FIG. 8 is a diagram showing the relationship between a temperature of an NOₓ selective reduction catalyst and an ammonia adsorption amount;

FIG. 9 is a flowchart schematically showing a control routine of inflow ratio control in the second embodiment;

FIG. 10 is a flowchart schematically showing a control routine of inflow ratio control in a third embodiment;

FIG. 11 is an overall view of an internal combustion engine of a fourth embodiment;

FIGS. 12A and 12B are views schematically showing an exhaust system of an internal combustion engine of a fifth embodiment;

FIG. 13 is a flowchart showing a control routine of inflow ratio control in a first modification of the fifth embodiment;

FIG. 14 is an overall view of an internal combustion engine of a sixth embodiment;

FIG. 15 is a flowchart schematically showing a control routine of inflow ratio control in the sixth embodiment;

FIG. 16 is an overall view of an internal combustion engine of a seventh embodiment;

FIG. 17 is an overall view of an internal combustion engine of a modification of the seventh embodiment;

FIG. 18 is a flowchart showing a control routine of inflow ratio control in the seventh embodiment;

FIG. 19 is a diagram schematically showing an exhaust system of an internal combustion engine of an eighth embodiment;

FIG. 20 is a diagram schematically showing an exhaust system of an internal combustion engine of a third modification of the eighth embodiment;

FIG. 21 is a diagram schematically showing an exhaust system of an internal combustion engine of a ninth embodiment; and

FIGS. 22A and 22B are overall views of an internal combustion engine of a 10th embodiment.

### DESCRIPTION OF THE PREFERRED EMBODIMENTS

Below, embodiments of the present invention will be explained with reference to the drawings. Note that, in the following explanation, similar components will be assigned the same reference numerals.

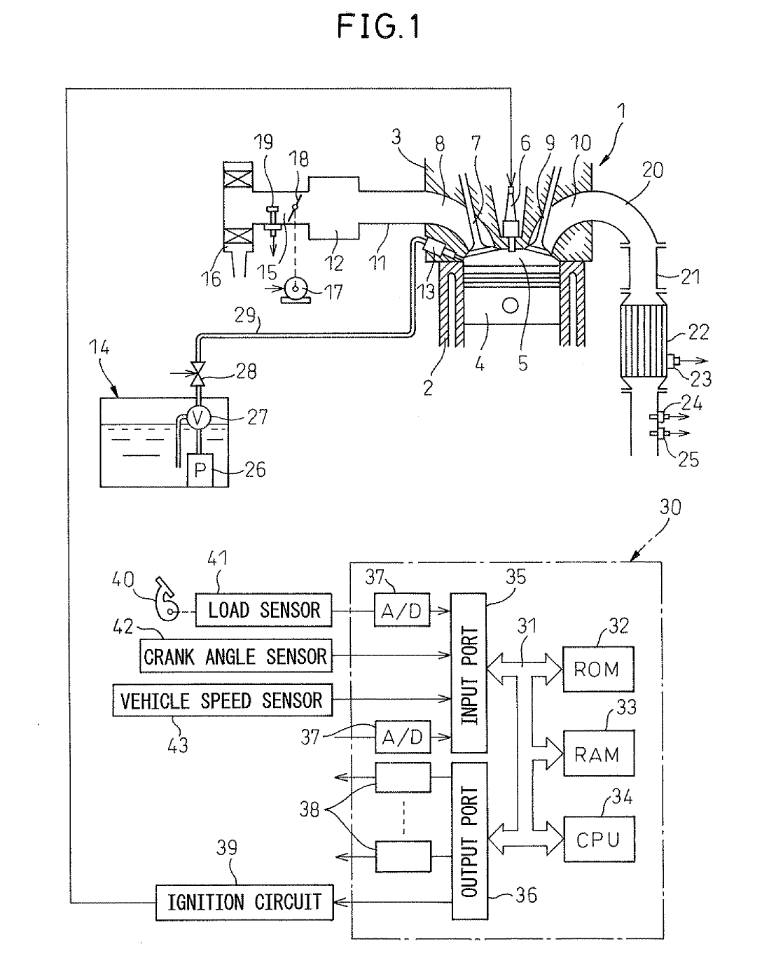

First, an ammonia burning internal combustion engine of a first embodiment of the present invention will be explained with reference to FIG. 1. Referring to FIG. 1, 1 indicates an engine body, 2 indicates a cylinder block, 3 indicates a cylinder head, 4 indicates a piston, 5 indicates a combustion chamber, 6 indicates an ignition device arranged at the center of the top surface of the combustion chamber 5, 7 indicates an intake valve, 8 indicates an intake port, 9 indicates an exhaust valve, and 10 indicates an exhaust port. In the embodiment shown in FIG. 1, the ignition device 6 is comprised by a plasma jet spark plug emitting a plasma jet. Further, in the cylinder head 3, an ammonia injector (ammonia feeding device) 13 for injecting the liquid ammonia toward the interior of the corresponding combustion chamber 5 is arranged. To this ammonia injector 13, liquid ammonia is fed from the fuel tank 14.

The intake port 8 is coupled through the intake branch pipes 11 to a surge tank 12. The surge tank 12 is coupled through an intake duct 15 to an air cleaner 16, and the inside of the intake duct 15 is arranged with a throttle valve 18 driven by an actuator 17 and an intake air detector 19 using a hot wire for example.

On the other hand, the exhaust port 10 is connected to an exhaust purifying catalyst 22 through an exhaust manifold 20 and an exhaust pipe 21. In the embodiment shown in FIG. 1, this exhaust purifying catalyst 22 is made an oxidation catalyst, a three-way catalyst, an NOₓ storage reduction catalyst, an NOₓ selective reduction catalyst, or the like able to purify ammonia and NOₓ contained in the exhaust gas. Further, a temperature sensor 23 detecting the temperature of the exhaust purifying catalyst 22 is arranged in the exhaust purifying catalyst 22, and an ammonia sensor (ammonia detector) 24 detecting the concentration of ammonia in the exhaust gas flowing in the exhaust pipe 21 and an NO sensor (NOₓ detector) 25 detecting the concentration of NOₓ in the exhaust gas flowing in the exhaust pipe 21 are arranged in the exhaust pipe 21 at a further downstream side from the exhaust purifying catalyst 22.

The interior of the fuel tank 14 is filled with about 0.8 MPa to 1.0 MPa of high pressure liquid ammonia. Inside this fuel tank 14, an ammonia feed pump 26 is arranged. A discharge port of this ammonia feed pump 26 is connected to the ammonia injector 13 through a relief valve 27 returning the liquid ammonia into the fuel tank 14 when a discharge pressure becomes a certain value or more, a shut-off valve 28 which is open during running of the engine, but is closed when the engine stops, and an ammonia feed pipe 29.

An electronic control unit 30 is comprised of a digital computer, provided with a ROM (read only memory) 32, RAM (random access memory) 33, CPU (microprocessor) 34, input port 35, and output port 36 all connected to each other through a bi-directional bus 31. The output signals of the intake air detector 19, temperature sensor 23, ammonia sensor 24, and NOₓ sensor 25 are input through corresponding AD converters 37 to the input port 35. An accelerator pedal 40 is connected to a load sensor 41 generating an output voltage proportional to the amount of depression of the accelerator pedal 40. The output voltage of the load sensor 41 is input through a corresponding AD converter 37 to the input port 35. Further, the input port 35 is connected to a crank angle sensor 42 generating an output pulse each time the crankshaft rotates by for example 10°. On the other hand, the output port 36 is connected to the ignition circuit 39 of the ignition device 36 and is further connected through the corresponding drive circuits to the ammonia injector 13, throttle valve driving actuator 17, ammonia feed pump 24, and shutoff valve 28.

In an ammonia burning internal combustion engine configured in this way, at the time of engine operation, liquid ammonia is injected from the ammonia injector 13 into the combustion chamber 5 of each cylinder. At this time, the liquid ammonia injected from the ammonia injector 13 is injected and immediately boils under vacuum and vaporizes.

The gaseous ammonia vaporized inside the combustion chamber 5 is ignited by the plasma jet jetted from the plasma jet spark plug 6 at the later half of the compression stroke. If the gaseous ammonia is made to completely burn, it theoretically becomes N₂ and H₂O, and CO₂ is not produced at all. However, in fact, unburned ammonia remains, and NOₓ forms from the combustion of the air-fuel mixture inside the combustion chamber 5. Therefore, unburned ammonia and NOₓ are exhausted from the combustion chamber 5. The unburned ammonia and NOₓ in the exhaust gas exhausted from the combustion chamber 5 are purified by the exhaust purifying catalyst 22 arranged in the engine exhaust passage as will be explained later.

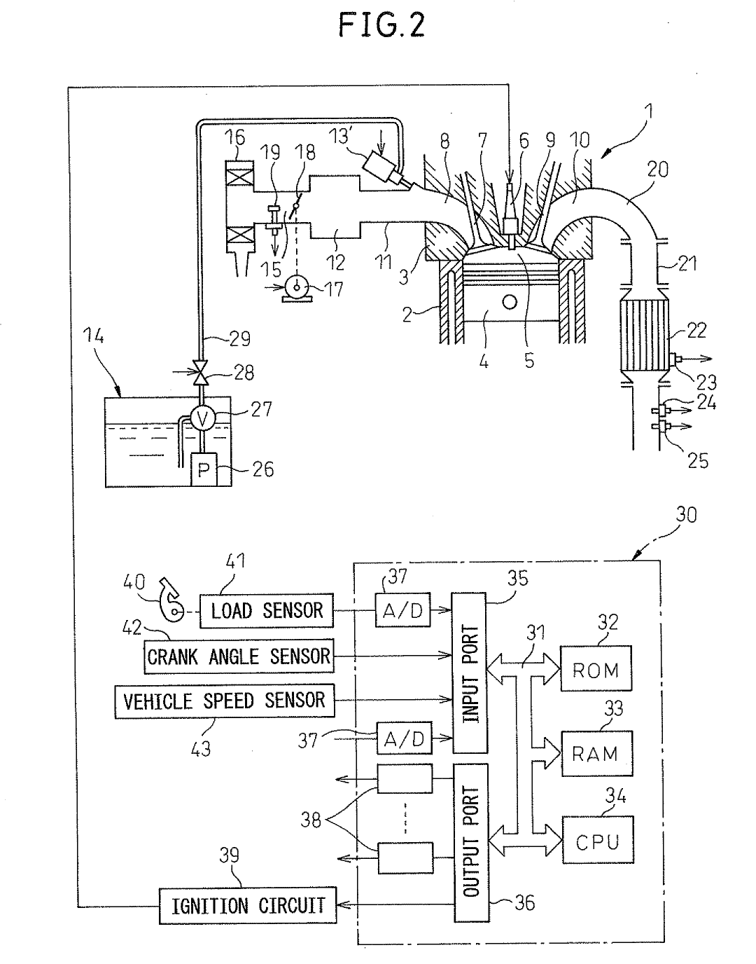

Note that, in the present embodiment, the ammonia injector 13 is arranged in the cylinder head 2 and injects liquid ammonia toward the interior of the combustion chamber 5. However, the ammonia injector may be arranged in for example the intake branch pipes 11 and configured so as to inject liquid ammonia toward the interior of the corresponding intake port 8 as well as shown in FIG. 2 (ammonia injector 13′ in FIG. 2).

Further, in the present embodiment, the internal combustion engine used is a spark ignition type internal combustion engine that ignites the air-fuel mixture with an ignition device 6. However, the internal combustion engine used may be a compression ignition type internal combustion engine not having an ignition device 6.

Further, in the above embodiment, ammonia is fed as liquid into the ammonia injector 13, and liquid ammonia is injected. However, a vaporizer may be arranged at the ammonia feed pipe 29 to vaporize the liquid ammonia and inject gaseous ammonia from the ammonia injector.

Further, in the above embodiment, the fuel used is only ammonia. However, ammonia, compared to the fossil fuels used since the past, is difficult to burn. If the fuel used is only ammonia, sometimes appropriate combustion is not performed inside the combustion chamber 5. Therefore, as fuel, in addition to ammonia, fuel other than ammonia fuel (hereinafter referred to as “non-ammonia fuel”) may be fed into the combustion chamber 5. Non-ammonia fuel may be fuel that is easier to burn than ammonia, for example, gasoline, diesel oil, liquefied natural gas, or hydrogen obtained by reforming ammonia, etc.

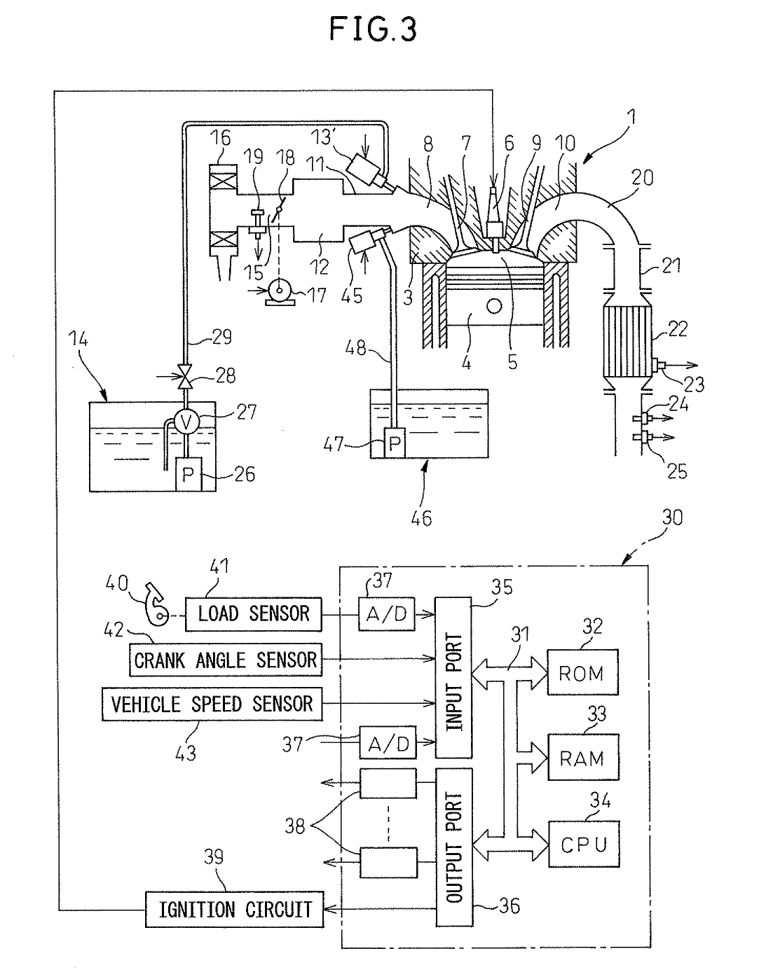

FIG. 3 is an example of an ammonia burning internal combustion engine when ammonia and non-ammonia fuel is fed into the combustion chamber 5. In the example shown in FIG. 3, a case is shown of using, as non-ammonia fuel, fuel that is ignited by a spark, for example, gasoline. In the example shown in FIG. 3, in the intake branch pipe 11, there is arranged a non-ammonia fuel injector 45 for injecting gasoline toward the corresponding intake port 8. Non-ammonia fuel is fed into this non-ammonia fuel injector 45 from a non-ammonia fuel storage tank 46. Inside the non-ammonia storage tank 46, there is arranged a non-ammonia fuel feed pump 47. The discharge outlet of this non-ammonia fuel feed pump 47 is connected through a non-ammonia fuel feed pipe (non-ammonia fuel feed passage) 48 to a non-ammonia fuel injector 45. Note that, the non-ammonia fuel injector may be arranged on the cylinder head 3 and inject non-ammonia fuel toward the corresponding combustion chamber 5.

Note that, the following embodiments and modifications, so long as not particularly necessary, explain an ammonia burning internal combustion engine that injects liquid ammonia toward a combustion chamber 5 and ignites the air-fuel mixture with an ignition device 6 wherein said ammonia burning internal combustion engine injects only liquid ammonia as fuel. However, in the following embodiments and modifications, various modifications are possible similar to the above embodiment.

In this regard, as explained above, the unburned ammonia and NOₓ may be exhausted from the combustion chamber 5. The unburned ammonia and NOₓ exhausted from the combustion chamber 5 in this way are purified in the exhaust purifying catalyst 22. At this time, the unburned ammonia and NOₓ are purified by for example reactions expressed by the following chemical reaction formulae.

8NH₃+6NO₂→7N₂+12H₂O

4NH₃+4NO+O₂→6H₂O+4N₂

As will be understood from the above chemical reaction formulas, the ratio of unburned ammonia and NOₓ which is necessary for purifying both of the unburned ammonia and NOₓ in the exhaust purifying catalyst 22 is fixed. Specifically, the ratio of the concentration by mole of the unburned ammonia and the concentration by mole of NOₓ must become a predetermined ratio from 4:3 to 1:1 (fluctuating in accordance with the ratio of NOₓ and NO) (hereinafter, the ratio of unburned ammonia and NOₓ which is necessary for completely purifying both of the unburned ammonia and NOₓ will be referred to as a “complete purifying ratio”).

Accordingly, when the ratio of unburned ammonia in the exhaust gas flowing into the exhaust purifying catalyst 22 is higher than the complete purifying ratio, the unburned ammonia ends up remaining even when the unburned ammonia and NOₓ react in the exhaust purifying catalyst 22. Conversely, when the ratio of unburned ammonia in the exhaust gas flowing into the exhaust purifying catalyst 22 is lower than the complete purifying ratio, NOₓ ends up remaining even when the unburned ammonia and NOₓ react in the exhaust purifying catalyst 22.

Therefore, in the present embodiment, in order to purify both of the unburned ammonia and NOₓ in the exhaust gas flowing into the exhaust purifying catalyst 22, the control parameters of the internal combustion engine are controlled so that the ratio of the unburned ammonia and NOₓ in the exhaust gas flowing into the exhaust purifying catalyst 22 becomes the complete purifying ratio.

In other words, in the present embodiment, the control parameters of the internal combustion engine are controlled so that the ratio of the unburned ammonia and NOₓ in the exhaust gas flowing into the exhaust purifying catalyst 22 becomes a ratio by which NOₓ in the exhaust gas flowing into the exhaust purifying catalyst 22 is purified exactly enough by the unburned ammonia in the exhaust gas, that is, a ratio by which the unburned ammonia in the exhaust gas flowing into the exhaust purifying catalyst 22 is purified exactly enough by NOₓ in the exhaust gas. Speaking in another way, in the present embodiment, the ratio of the unburned ammonia and NOx in the exhaust gas flowing into the exhaust purifying catalyst 22 is controlled to a ratio by which all of the unburned ammonia in the exhaust gas flowing into the exhaust purifying catalyst 22 is oxidized by NOₓ in the exhaust gas flowing into the exhaust purifying catalyst 22 and all of NOₓ in the exhaust gas flowing into the exhaust purifying catalyst 22 is reduced by the unburned ammonia in the exhaust gas flowing into the exhaust purifying catalyst 22.

In this way, by controlling the ratio of the unburned ammonia and NOx in the exhaust gas flowing into the exhaust purifying catalyst 22 to become the complete purifying ratio, it becomes possible to almost completely purify the unburned ammonia and NOₓ in the exhaust purifying catalyst 22, so outflow of the unburned ammonia and NOₓ from the exhaust purifying catalyst 22 can be suppressed.

Here, as methods of controlling the ratio of the unburned ammonia and NOx in the exhaust gas flowing into the exhaust purifying catalyst 22, for example, the following methods can be mentioned.

First, as a first method, there can be mentioned control of the ignition timing of the air-fuel mixture in the combustion chamber 5. In general, when the ignition timing of the air-fuel mixture is advanced, a combustion temperature of the air-fuel mixture in the combustion chamber 5 rises, therefore the ammonia in the air-fuel mixture becomes easier to be oxidized, and NOₓ becomes easier to be produced. Accordingly, by advancing the ignition timing of the air-fuel mixture by the ignition device 6, the ratio of the unburned ammonia in the exhaust gas exhausted from the combustion chamber 5 can be made lower. Accordingly, the ratio of the unburned ammonia in the exhaust gas flowing into the exhaust purifying catalyst 22 can be made lower. Conversely, by retarding the ignition timing of the air-fuel mixture by the ignition device 6, the ratio of the unburned ammonia in the exhaust gas exhausted from the combustion chamber 5 can be made higher. Accordingly, the ratio of the unburned ammonia in the exhaust gas flowing into the exhaust purifying catalyst 22 can be made higher.

Accordingly, in the first method, specifically, when the ratio of the unburned ammonia in the exhaust gas flowing into the exhaust purifying catalyst 22 is made lower (that is, the ratio of NOₓ in the exhaust gas flowing into the exhaust purifying catalyst 22 is made higher), the ignition timing of the air-fuel mixture by the ignition device 6 is advanced. When the ratio of the unburned ammonia in the exhaust gas flowing into the exhaust purifying catalyst 22 is made higher (that is, the ratio of NOₓ in the exhaust gas flowing into the exhaust purifying catalyst 22 is made lower), the ignition timing of the air-fuel mixture by the ignition device 6 is retarded.

Note that, in the present embodiment, the ignition timing by the ignition device 6 is controlled since a spark ignition type internal combustion engine is used. However, when a compression ignition type internal combustion engine is used, the ratio of the unburned ammonia and NOₓ in the exhaust gas flowing into the exhaust purifying catalyst 22 can be controlled by controlling the igniting timing of the air-fuel mixture in the combustion chamber 5, that is, the injection timing of the fuel from the injector for directly injecting the fuel into a cylinder.

As a second method, there can be mentioned control of the air-fuel ratio of the air-fuel mixture fed into the combustion chamber 5. In general, when the air-fuel ratio of the air-fuel mixture fed into the combustion chamber 5 is rich, a lot of unburned ammonia is contained in the exhaust gas exhausted from the combustion chamber 5. In particular, when the degree of richness of the air-fuel ratio of the air-fuel mixture fed into the combustion chamber 5 is made higher, the amount of the unburned ammonia which is contained in the exhaust gas exhausted from the combustion chamber 5 becomes larger.

Accordingly, in the second method, specifically, when the ratio of the unburned ammonia in the exhaust gas flowing into the exhaust purifying catalyst 22 is made higher, the air-fuel ratio of the air-fuel mixture fed into the combustion chamber 5 is made lower (the degree of richness is made higher). Conversely, when the ratio of the unburned ammonia in the exhaust gas flowing into the exhaust purifying catalyst 22 is made higher, the air-fuel ratio of the air-fuel mixture fed into the combustion chamber 5 is made higher (the degree of richness is made lower).

As a third method, there can be mentioned direct injection of ammonia into the combustion chamber 5 from the ammonia injector 13 in the expansion stroke or exhaust stroke. In general, when the fuel is injected into the combustion chamber 5 in the expansion stroke or exhaust stroke, the injected fuel will not burn much at all in the combustion chamber 5, but will be exhausted from the combustion chamber 5 as it is. Accordingly, by directly injecting ammonia into the combustion chamber 5 from the ammonia injector 13 in the expansion stroke or exhaust stroke, the ratio of the unburned ammonia in the exhaust gas flowing into the exhaust purifying catalyst 22 can be made higher. In particular, the larger the amount of ammonia directly injected into the combustion chamber 5 from the ammonia injector 13 in the expansion stroke or exhaust stroke, the higher the ratio of ammonia in the exhaust gas flowing into the exhaust purifying catalyst 22.

Accordingly, in the third method, specifically, when the ratio of the unburned ammonia in the exhaust gas flowing into the exhaust purifying catalyst 22 is made higher, ammonia becomes directly injected into the combustion chamber 5 from the ammonia injector 13 in the expansion stroke or exhaust stroke, or the injection amount thereof is made larger. Conversely, at the time when the ratio of the unburned ammonia in the exhaust gas flowing into the exhaust purifying catalyst 22 is made lower, the injection amount of ammonia into the combustion chamber 5 from the ammonia injector 13 in the expansion stroke or exhaust stroke is made smaller, or the direct injection of ammonia into the combustion chamber 5 from the ammonia injector 13 in the expansion stroke or exhaust stroke is suspended.

As a fourth method, there can be mentioned control of the ratio of the non-ammonia fuel fed into the combustion chamber 5. As shown in FIG. 3, in a case where non-ammonia fuel is fed into the combustion chamber 5 in addition to ammonia, when the ratio of the non-ammonia fuel in the fuel (ammonia and non-ammonia fuel) fed into the combustion chamber 5 increases, the amount of ammonia fed into the combustion chamber 5 is reduced by that amount. In this way, when the amount of ammonia fed into the combustion chamber 5 is reduced, the amount of the unburned ammonia contained in the exhaust gas exhausted from the combustion chamber 5 is reduced as well along with that. On the other hand, due to reduction of the amount of ammonia fed into the combustion chamber 5, the amount of NOₓ generated along with combustion of ammonia is reduced as well. However, NOₓ is generated by combustion of the non-ammonia fuel as well, so when the amount of ammonia fed into the combustion chamber 5 is reduced, in comparison with the reduction of the amount of the unburned ammonia contained in the exhaust gas exhausted from the combustion chamber 5, the degree of reduction of the amount of NOₓ contained in the exhaust gas exhausted from the combustion chamber 5 is smaller. Accordingly, by raising the ratio of the non-ammonia fuel in the fuel fed into the combustion chamber 5, the ratio of the unburned ammonia in the exhaust gas flowing into the exhaust purifying catalyst 22 can be made lower.

Accordingly, in the fourth method, specifically, when the ratio of the unburned ammonia in the exhaust gas flowing into the exhaust purifying catalyst 22 is made lower, the ratio of the non-ammonia fuel in fuel fed into the combustion chamber 5 is made higher. Conversely, when the ratio of the unburned ammonia in the exhaust gas flowing into the exhaust purifying catalyst 22 is made higher, the ratio of the non-ammonia fuel in fuel fed into the combustion chamber 5 is made lower.

As a fifth method, there can be mentioned control of the injection amount of the non-ammonia fuel directly injected into the combustion chamber 5 in the expansion stroke. In the example shown in FIG. 3, a non-ammonia fuel injector 45 for injecting the non-ammonia fuel injects the fuel toward the interior of the intake port 8. However, it is also possible to arrange the non-ammonia fuel injector so that the non-ammonia fuel can be directly injected into the combustion chamber 5. When the non-ammonia fuel is injected into the combustion chamber 5 from such a non-ammonia fuel injector in the expansion stroke, the injected non-ammonia fuel burns in the expanding combustion chamber. The combustion gas in the combustion chamber 5 becomes higher in temperature along with this. When the combustion gas becomes higher in temperature in this way, the ammonia contained in the combustion gas is oxidized. As a result, the amount of the unburned ammonia in the exhaust gas flowing into the exhaust purifying catalyst 22 is reduced. Accordingly, by injecting the non-ammonia fuel into the combustion chamber 5 in the expansion stroke, the ratio of the unburned ammonia flowing into the exhaust purifying catalyst 22 can be made lower. Further, the larger the injection amount of the non-ammonia fuel directly injected into the combustion chamber 5 in the expansion stroke, the lower the ratio of the ammonia flowing into the exhaust purifying catalyst 22.

Accordingly, in the fifth method, specifically, when the ratio of the unburned ammonia in the exhaust gas flowing into the exhaust purifying catalyst 22 is made lower, the non-ammonia fuel is injected into the combustion chamber 5 in the expansion stroke and the injection amount thereof is made larger. When the ratio of the unburned ammonia in the exhaust gas flowing into the exhaust purifying catalyst 22 is made higher, the injection amount of the non-ammonia fuel directly injected into the combustion chamber 5 in the expansion stroke is made smaller or the direct injection of the non-ammonia fuel into the combustion chamber 5 in the expansion stroke is suspended.

In this regard, in the present embodiment, as explained above, the control parameters of the internal combustion engine (that is, the ignition timing by the ignition device 6, the air-fuel ratio of the air-fuel mixture fed into the combustion chamber 5, the injection amount of ammonia from the ammonia injector into the combustion chamber 5 in the expansion stroke or exhaust stroke, the ratio of the non-ammonia fuel fed into the combustion chamber 5, the injection amount of the non-ammonia fuel into the combustion chamber 5 in the expansion stroke, and so on) are controlled so that the ratio of the unburned ammonia and NOₓ in the exhaust gas flowing into the exhaust purifying catalyst 22 becomes the complete purifying ratio. In more detail, for each engine load and each engine rotation speed, the values of the control parameters whereby the ratio of the unburned ammonia and NOₓ in the exhaust gas flowing into the exhaust purifying catalyst 22 becomes the complete purifying ratio are found in advance experimentally or by computation and stored in the form of a map in the ROM 32 of the ECU 30. Next, during actual running of the engine, based on the engine load and engine rotation speed, the target values of the control parameters of the internal combustion engine are calculated by the map, and the control parameters are controlled so as to become the target values.

However, even if the control parameters of the internal combustion engine are controlled in this way, due to individual differences of internal combustion engines and aging, etc., sometimes the ratio of the unburned ammonia and NOₓ in the exhaust gas flowing into the exhaust purifying catalyst 22 does not become the complete purifying ratio. When particularly an oxidation catalyst or three-way catalyst is used as the exhaust purifying catalyst 22, if the ratio of the unburned ammonia in the exhaust gas flowing into the exhaust purifying catalyst 22 becomes higher than the complete purifying ratio, sometimes the unburned ammonia will flow out of the exhaust purifying catalyst 22. Conversely, if the ratio of NOₓ in the exhaust gas flowing into the exhaust purifying catalyst 22 becomes higher than the complete purifying ratio, sometimes NOₓ will flow out of the exhaust purifying catalyst 22.

Therefore, in the present embodiment, in addition to the control of the control parameters of the internal combustion engine as explained above, the ratio of the unburned ammonia and NOₓ in the exhaust gas flowing into the exhaust purifying catalyst 22 is feedback controlled in accordance with concentrations of the unburned ammonia and NOₓ contained in the exhaust gas flowing out of the exhaust purifying catalyst 22.

Specifically, when unburned ammonia is detected in the exhaust gas flowing in the exhaust pipe 21 by the ammonia sensor 24, control is carried out so that the ratio of the unburned ammonia in the exhaust gas flowing into the exhaust purifying catalyst 22 is lowered (for example, advance of the ignition timing by the ignition device 6). In particular, in the present embodiment, when the concentration of the unburned ammonia in the exhaust gas flowing in the exhaust pipe 21 which is detected by the ammonia sensor 24 is high, in comparison with the case where it is low, control is carried out so that the ratio of the unburned ammonia in the exhaust gas flowing into the exhaust purifying catalyst 22 is greatly lowered (for example, the ignition timing by the ignition device 6 is greatly advanced).

Conversely, when NOₓ is detected in the exhaust gas flowing in the exhaust pipe 21 by the NOₓ sensor 25, control is performed so that the ratio of NOₓ in the exhaust gas flowing into the exhaust purifying catalyst 22 is lowered (for example, retardation of the ignition timing by the ignition device 6). In particular, in the present embodiment, when the concentration of NOₓ in the exhaust gas flowing in the exhaust pipe 21 which is detected by the NOₓ sensor 25 is high, control is carried out so that the ratio of NOₓ in the exhaust gas flowing into the exhaust purifying catalyst 22 is greatly lowered in comparison with the case where the concentration is low (for example, the ignition timing by the ignition device 6 is greatly retarded).

In this regard, the purifying capability of the ammonia and NOₓ by the exhaust purifying catalyst is limited. For this reason, when large amounts of unburned ammonia and NOₓ flow into the exhaust purifying catalyst 22, even when the ratio of the inflow unburned ammonia and NOₓ is the complete purifying ratio, the ammonia and NOₓ end up flowing out of the exhaust purifying catalyst 22. Therefore, in the present embodiment, control is performed so that the flow rate of NOₓ flowing into the exhaust purifying catalyst 22 becomes not more than the maximum amount of NOₓ which can be purified per unit time (hereinafter, referred to as a “maximum purifiable NOₓ amount”) in the exhaust purifying catalyst 22. Alternatively, in the present embodiment, control is performed so that the flow rate of ammonia flowing into the exhaust purifying catalyst 22 becomes not more than the maximum amount of ammonia which can be purified per unit time (hereinafter, referred to as a “maximum purifiable ammonia amount”) in the exhaust purifying catalyst 22.

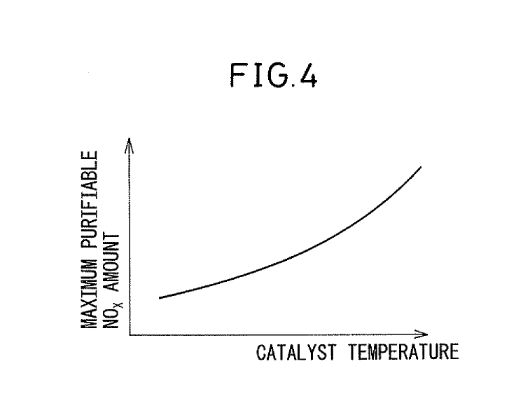

FIG. 4 is a view showing the relationship between the temperature of the exhaust purifying catalyst 22 and the maximum purifiable NOₓ amount. As seen from FIG. 4, the higher the temperature of the exhaust purifying catalyst 22, the larger the maximum purifiable NOₓ amount of the exhaust purifying catalyst 22. Accordingly, in the present embodiment, the temperature of the exhaust purifying catalyst 22 is detected by the temperature sensor 23, the maximum purifiable NOₓ amount is calculated by using the map as shown in FIG. 4 based on the detected temperature of the exhaust purifying catalyst 22, and the flow rate of NOₓ flowing into the exhaust purifying catalyst 22 is controlled so that it becomes not more than the calculated maximum purifiable NOₓ amount.

Further, the relationship between the temperature of the exhaust purifying catalyst 22 and the maximum purifiable ammonia amount becomes the relationship the same as the relationship between the temperature of the exhaust purifying catalyst 22 and the maximum purifiable NOₓ amount shown in FIG. 4 as well. Accordingly, when changing this viewpoint, in the present embodiment, it can be said that the maximum purifiable ammonia amount is calculated by using the map as shown in FIG. 4 based on the temperature of the exhaust purifying catalyst 22 detected by the temperature sensor 23, and the flow rate of the unburned ammonia flowing into the exhaust purifying catalyst is controlled so that it becomes not more than the calculated maximum purifiable ammonia amount.

Here, as the method of controlling the flow rate of NOₓ and unburned ammonia flowing into the exhaust purifying catalyst 22, there can be mentioned for example control of the ratio of the non-ammonia fuel fed into the combustion chamber 5. As shown in FIG. 3, when a non-ammonia fuel is fed into the combustion chamber 5 in addition to ammonia, if the ratio of the non-ammonia fuel in the fuel fed into the combustion chamber 5 increases, the amount of ammonia fed into the combustion chamber 5 is reduced by that amount. In this way, when the amount of ammonia fed into the combustion chamber 5 is reduced, the amount of the unburned ammonia contained in the exhaust gas exhausted from the combustion chamber 5 is reduced along with that as well. Further, due to reduction of the amount of ammonia fed into the combustion chamber 5, the amount of NOₓ generated along with the combustion of ammonia becomes smaller as well. Accordingly, by raising the ratio of the non-ammonia fuel in the fuel fed into the combustion chamber 5, the flow rate of NOₓ and unburned ammonia flowing into the exhaust purifying catalyst 22 can be reduced.

Note that, in the above embodiment, the flow rates of NOₓ and unburned ammonia flowing into the exhaust purifying catalyst 22 are controlled so as to become not more than the maximum purifiable NOₓ amount and maximum purifiable ammonia amount in order to suppress outflow of the unburned ammonia or NOₓ from the exhaust purifying catalyst 22. However, it is also possible to control the temperature of the exhaust purifying catalyst 22 so that the flow rates of NOₓ and unburned ammonia flowing into the exhaust purifying catalyst 22 become not more than the maximum purifiable NOₓ amount and maximum purifiable ammonia amount. In this case, the flow rate of NOₓ flowing into the exhaust purifying catalyst 22 is estimated from the running state of the engine, and the maximum purifiable NOₓ amount is calculated based on the temperature of the exhaust purifying catalyst 22. When the estimated flow rate of NOₓ is larger than the calculated maximum purifiable NOₓ amount, the temperature of the exhaust purifying catalyst 22 is raised. Due to this, the maximum purifiable NOₓ amount by the exhaust purifying catalyst 22 increases. As a result, the flow rate of NOₓ flowing into the exhaust purifying catalyst 22 can be controlled to not more than the maximum purifiable NOₓ amount. Alternatively, the flow rate of the unburned ammonia flowing into the exhaust purifying catalyst 22 may be estimated from the running state of the engine and the maximum purifiable ammonia amount may be calculated based on the temperature of the exhaust purifying catalyst 22. The temperature of the exhaust purifying catalyst 22 may be raised when the estimated flow rate of the unburned ammonia is larger than the maximum purifiable ammonia amount.

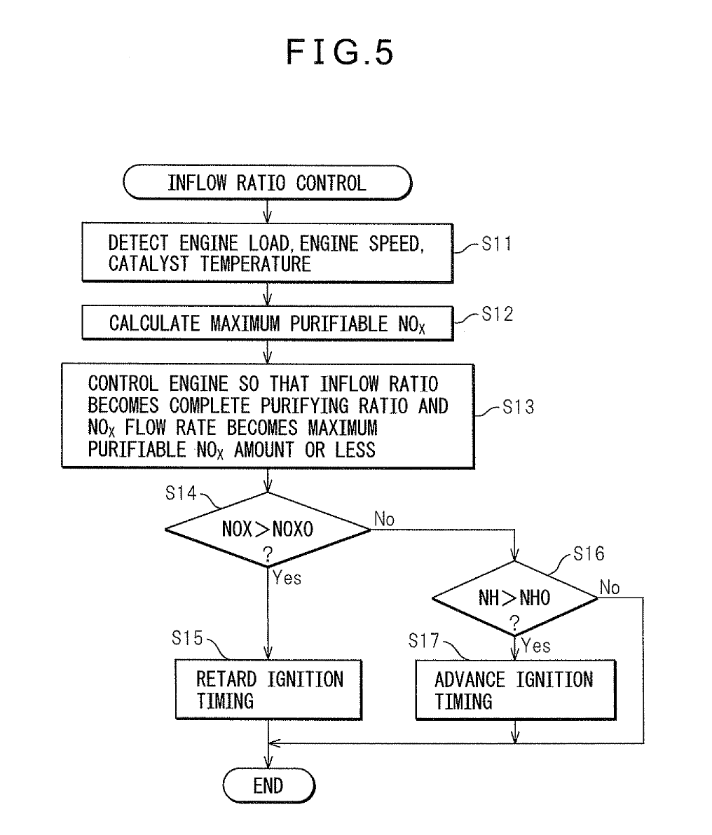

FIG. 5 is a flowchart showing a control routine of inflow ratio control for controlling the ratio of NOₓ and unburned ammonia flowing into the exhaust purifying catalyst 22. As shown in FIG. 5, first, at step S11, the engine load, engine speed, and the temperature of the exhaust purifying catalyst 22 are detected by the load sensor 41, crank angle sensor 42, and temperature sensor 23. Next, at step S12, based on the temperature of the exhaust purifying catalyst 22 detected at step S13, the maximum purifiable NOₓ amount is calculated by using a map such as shown in FIG. 4. Next, at step S13, based on the engine load and engine speed detected at step S13, control parameters of the internal combustion engine (for example, ignition timing, and injection timing and injection amount of ammonia and non-ammonia fuel) are calculated so that the ratio of NOₓ and the unburned ammonia flowing into the exhaust purifying catalyst 22 becomes the complete purifying ratio and the flow rate of NOₓ flowing into the exhaust purifying catalyst 22 becomes not more than the maximum purifiable NOₓ amount, and the internal combustion engine is controlled based on these control parameters.

Next, at step S14, it is determined whether an NOₓ concentration NOX detected by the NOₓ sensor 25 is higher than a predetermined value NOX0 close to 0. When it is determined that the NOₓ concentration NOX detected by the NOₓ sensor 25 is higher than the predetermined value NOX0, the ratio of NOₓ flowing into the exhaust purifying catalyst 22 is higher than the complete purifying ratio, therefore the routine proceeds to step S15 where control is performed so that the ratio of the unburned ammonia flowing into the exhaust purifying catalyst 22 becomes higher, for example, the ignition timing is retarded.

On the other hand, when it is determined at step S14 that the NOₓ concentration NOX detected by the NOₓ sensor 25 is not more than the predetermined value NOX0, next at step S16 it is determined whether the ammonia concentration NH detected by the ammonia sensor 24 is higher than a predetermined value NH0 close to 0. When it is determined that the ammonia concentration NH detected by the ammonia sensor 24 is higher than the predetermined value NH0, the ratio of the unburned ammonia flowing into the exhaust purifying catalyst 22 is higher than the complete purifying ratio, therefore the routine proceeds to step S17 where control is performed so that the ratio of NOₓ flowing into the exhaust purifying catalyst 22 becomes higher, for example, the ignition timing is advanced. On the other hand, when it is determined at step S16 that the ammonia concentration NH detected by the ammonia sensor 24 is not more than the predetermined value NH0, it is considered that the ratio of NOₓ and unburned ammonia flowing into the exhaust purifying catalyst 22 has become the complete purifying ratio, therefore the control routine is ended as it is.

In this regard, in the above embodiment, the NOₓ sensor 24 and ammonia sensor 25, i.e., two sensors, are provided at a downstream side of the exhaust purifying catalyst 22. However, it is also possible provide only the NOₓ sensor 24 at a downstream side of the exhaust purifying catalyst 22. Note that, in this case, as the NOₓ sensor 24, use is made of a sensor where the output voltage rises not only when the concentration of NOₓ in the exhaust gas rises, but the output voltage also rises when the concentration of the unburned ammonia in the exhaust gas rises.

When such an NOₓ sensor 24 is used, the output value of the NOₓ sensor 24 changes in accordance with the concentration obtained by totaling the concentration of NOₓ and the concentration of the unburned ammonia in the exhaust gas. Accordingly, when the output value of the NOₓ sensor rises, it cannot be determined whether the rise of the output value is caused by the increase of the concentration of NOₓ in the exhaust gas or by the increase of the concentration of the unburned ammonia in the exhaust gas.

Therefore, when such an NOₓ sensor 24 is used, at the time when the output value of the NOₓ sensor 24 is not 0, that is, at the time when either of NOₓ or unburned ammonia is contained in the exhaust gas, for example, the ignition timing by the ignition device 6 is advanced (or retarded) to forcibly raise the ratio of the unburned ammonia (or NOₓ) in the exhaust gas flowing into the exhaust purifying catalyst 22.

Here, when NOₓ is contained in the exhaust gas, that is, when NOₓ becomes excessive in the exhaust purifying catalyst 22, if the ratio of the unburned ammonia in the exhaust gas flowing into the exhaust purifying catalyst 22 is raised, the NOₓ which has become excess reacts with the unburned ammonia and is reduced along with this, therefore the concentration of NOₓ in the exhaust gas flowing out of the exhaust purifying catalyst 22 is lowered. Accordingly, at the time when the ratio of the unburned ammonia in the exhaust gas flowing into the exhaust purifying catalyst 22 is forcibly raised, if the output value of the NOₓ sensor 24 is lowered, it can be determined that it is NOₓ that is flowing out of the exhaust purifying catalyst 22. Accordingly, in this case, control is carried out so that the ratio of the unburned ammonia flowing into the exhaust purifying catalyst 22 becomes high, for example, the ignition timing is retarded.

On the other hand, when unburned ammonia is contained in the exhaust gas, that is, when unburned ammonia becomes excessive in the exhaust purifying catalyst 22, if the ratio of the unburned ammonia in the exhaust gas flowing into the exhaust purifying catalyst 22 is made higher, the flow rate of the unburned ammonia flowing out of the exhaust purifying catalyst 22 increases by that amount. Accordingly, at the time when the ratio of the unburned ammonia in the exhaust gas flowing into the exhaust purifying catalyst 22 is forcibly made higher, if the output value of the NOₓ sensor 24 rises, it can be determined that what is flowing out of the exhaust purifying catalyst 22 is the unburned ammonia. Accordingly, in this case, control is performed so that the ratio of NOₓ flowing into the exhaust purifying catalyst 22 becomes higher, for example, the ignition timing is advanced.

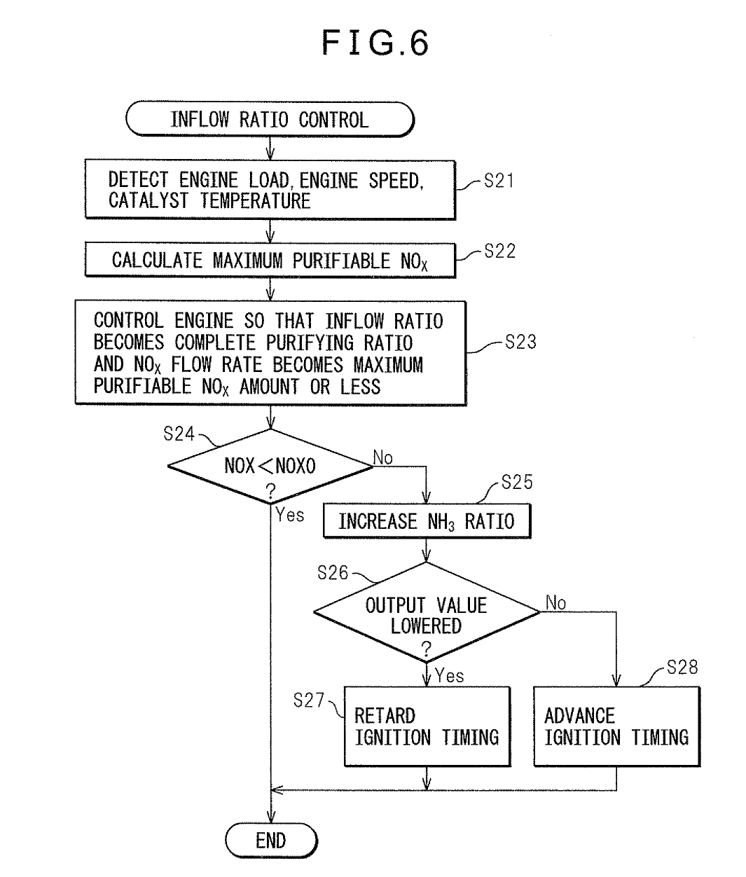

FIG. 6 is a flowchart showing a control routine of the inflow ratio control for controlling the ratio of NOₓ and unburned ammonia flowing into the exhaust purifying catalyst 22 in a case where one NOₓ sensor reacting with both of NOₓ and ammonia is used. Steps S21 to S23 shown in FIG. 6 are the same as steps S11 to S13 shown in FIG. 5, so an explanation will be omitted.

At step S24, it is determined whether the output value NOX of the NOₓ sensor 24 is lower than a predetermined value NOX0 close to 0. When it is determined that the output value NOX of the NOₓ sensor 24 is lower than the predetermined value NOX0, almost no NOₓ and no unburned ammonia flow out of the exhaust purifying catalyst 22, so the control routine is ended. On the other hand, when it is determined at step S24 that the output value NOX of the NOₓ sensor 24 is the predetermined value NOX0 or more, the routine proceeds to step S25. At step S25, control is performed so that the ratio of the unburned ammonia flowing into the exhaust purifying catalyst 22 becomes slightly higher, for example, the ignition timing is retarded. Next, at step S26, it is determined whether the output value of the NOₓ sensor 24 is lowered by the control of step S25. When it is determined that the output of the NOₓ sensor 24 is lowered, it is considered that what is flowing out of the exhaust purifying catalyst 22 is NOₓ, therefore the routine proceeds to step S27 where the ignition timing is retarded. On the other hand, when it is determined at step S26 that the output of the NOₓ sensor 24 is not lowered, it is considered that what is flowing out of the exhaust purifying catalyst 22 is the unburned ammonia, therefore the routine proceeds to step S28 where the ignition timing is advanced.

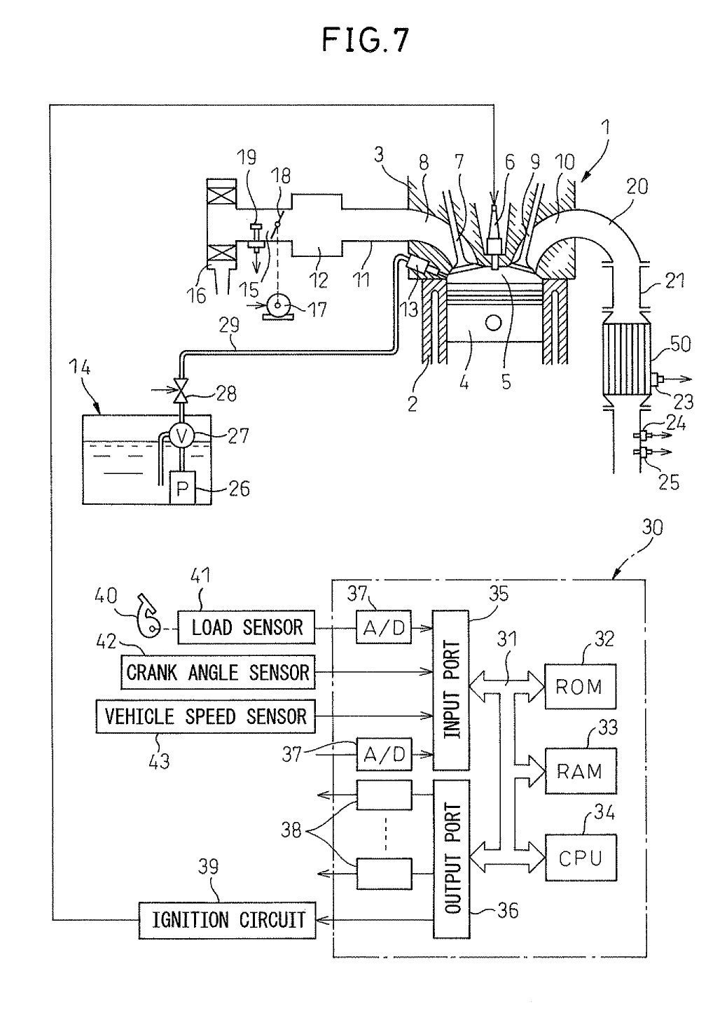

Next, an ammonia burning internal combustion engine of a second embodiment of the present invention will be explained with reference to FIG. 7. The configuration of the internal combustion engine of the present embodiment shown in FIG. 7 is basically the same as the configuration of the internal combustion engine of the first embodiment. Explanations of similar configurations will be omitted.

In the ammonia burning internal combustion engine of the second embodiment shown in FIG. 7, an NOₓ selective reduction catalyst 50 is provided as the exhaust purifying catalyst 22 of the first embodiment described above. The NOₓ selective reduction catalyst 50 is a catalyst which adsorbs the unburned ammonia in the inflowing exhaust gas and can selectively reduce NOₓ by the adsorbed ammonia when NOₓ is contained in the inflowing exhaust gas.

When such an NOₓ selective reduction catalyst 50 is used, in a state where ammonia is adsorbed at the NOₓ selective reduction catalyst 50, even when NOₓ is contained in the exhaust gas flowing into the NOₓ selective reduction catalyst 50, the NOₓ can be purified in the NOₓ selective reduction catalyst 50. Conversely, the amount of ammonia which can be adsorbed at the NOₓ selective reduction catalyst 50 is limited. Therefore, if ammonia is made to flow into the catalyst in the state where ammonia is adsorbed at the NOₓ selective reduction catalyst 50, the amount of ammonia adsorbed at the NOₓ selective reduction catalyst 50 will exceed the limit amount and there is possibility that ammonia will flow out of the NOₓ selective reduction catalyst 50.

Therefore, in the present embodiment, in a state where ammonia is adsorbed at the NOₓ selective reduction catalyst 50, the ratio of NOₓ and the unburned ammonia flowing into the NOₓ selective reduction catalyst 50 is controlled so that the ratio of NOₓ in the exhaust gas flowing into the NOₓ selective reduction catalyst 50 becomes higher than the complete purifying ratio. In other words, in the present embodiment, the ratio of NOₓ and unburned ammonia flowing into the NOₓ selective reduction catalyst 50 is controlled to a ratio so that the NOₓ becomes larger than the ratio by which the NOₓ in the exhaust gas flowing into the NOₓ selective reduction catalyst 50 is purified exactly enough by the unburned ammonia in the exhaust gas. Due to this, the unburned ammonia in the exhaust gas flowing into the NOₓ selective reduction catalyst 50 is all oxidized by the NOₓ in the exhaust gas flowing into the NOₓ selective reduction catalyst 50, and NOₓ which does not react with the unburned ammonia, but remains, is reduced and purified by the ammonia adsorbed at the NOₓ selective reduction catalyst 50.

Here, a portion of the NOₓ flowing into the NOₓ selective reduction catalyst 50 is reduced and purified by ammonia adsorbed at the NOₓ selective reduction catalyst 50. However, there is a limit to the amount of ammonia which can be disassociated from the NOₓ selective reduction catalyst 50 per unit time. Accordingly, when the flow rate of NOₓ is too large relative to the flow rate of the unburned ammonia in the exhaust gas flowing into the NOₓ selective reduction catalyst 50, it becomes impossible to purify NOₓ even by the ammonia adsorbed at the NOₓ selective reduction catalyst 50.

Therefore, in the present embodiment, the ratio of NOₓ and unburned ammonia in the exhaust gas flowing into the NOₓ selective reduction catalyst 50 is controlled so that the flow rate of the excess NOₓ which was not purified by the unburned ammonia in the exhaust gas flowing into the NOₓ selective reduction catalyst 50 due to the fact that the ratio of NOₓ in the exhaust gas flowing into the NOₓ selective reduction catalyst 50 was higher than the complete purifying ratio becomes an amount by which purifying is possible by the unburned ammonia in the maximum amount of ammonia which can be disassociated from the NOₓ selective reduction catalyst 50 per unit time (hereinafter, referred to as a “maximum disassociated ammonia amount”). In other words, the ratio of NOₓ and unburned ammonia in the exhaust gas flowing into the NOₓ selective reduction catalyst 50 is controlled to a ratio by which the sum of the maximum disassociable ammonia amount and the flow rate of the unburned ammonia in the exhaust gas flowing into the NOₓ selective reduction catalyst 50 becomes smaller than the amount by which exactly enough purifying is carried out by NOₓ in the exhaust gas flowing into the NOₓ selective reduction catalyst 50. Due to this, NOₓ which was not purified by the unburned ammonia flowed into the NOₓ selective reduction catalyst 50 becomes be reliably purified by the ammonia adsorbed at the NOₓ selective reduction catalyst 50.

Note that, the maximum disassociated ammonia amount changes in accordance with the amount of ammonia adsorbed at the NOₓ selective reduction catalyst 50, the flow rate of the exhaust gas flowing into the NOₓ selective reduction catalyst 50, the temperature of the NOₓ selective reduction catalyst 50, and so on. Namely, the larger the amount of ammonia adsorbed at the NOₓ selective reduction catalyst 50, the larger the maximum disassociated ammonia amount. The larger the flow rate of the exhaust gas flowing into the NOₓ selective reduction catalyst 50, the larger the maximum disassociated ammonia amount. Further, the higher the temperature of the NOₓ selective reduction catalyst 50, the larger the maximum disassociated ammonia amount. Accordingly, in the present embodiment, the maximum disassociated ammonia amount is calculated based on the amount of ammonia adsorbed at the NOₓ selective reduction catalyst 50 and so on, and the ratio of NOₓ and the unburned ammonia in the exhaust gas flowing into the NOₓ selective reduction catalyst 50 is set based on the calculated maximum disassociated ammonia amount.

In this regard, when the ratio of NOₓ and unburned ammonia in the exhaust gas flowing into the NOₓ selective reduction catalyst 50 is controlled as explained above, the amount of ammonia adsorbed at the NOₓ selective reduction catalyst 50 is gradually reduced and finally becomes zero. When the amount of ammonia adsorbed at the NOₓ selective reduction catalyst 50 becomes zero, the excess NOₓ flowing into the NOₓ selective reduction catalyst 50 is no longer purified. As a result, NOₓ ends up flowing out of the NOₓ selective reduction catalyst 50.

Therefore, in the present embodiment, when the amount of ammonia adsorbed at the NOₓ selective reduction catalyst 50 becomes smaller than the minimum reference amount close to 0, in order to restore the ammonia adsorption amount of the NOₓ selective reduction catalyst 50, an ammonia recovery treatment is executed making the ratio of the unburned ammonia in the exhaust gas flowing into the NOₓ selective reduction catalyst 50 higher than the complete purifying ratio. Due to this, excessive unburned ammonia contained in the exhaust gas flowing into the NOₓ selective reduction catalyst 50 is adsorbed at the NOₓ selective reduction catalyst 50, so the amount of ammonia adsorbed at the NOₓ selective reduction catalyst 50 can be restored.

Note, the amount of ammonia which can be adsorbed by the NOₓ selective reduction catalyst 50 is limited. Therefore, when the amount of ammonia adsorbed at the NOₓ selective reduction catalyst 50 exceeds the ammonia adsorption limit amount, ammonia is no longer adsorbed at the NOₓ selective reduction catalyst 50. Further, when the amount of ammonia adsorbed at the NOₓ selective reduction catalyst 50 is near the ammonia adsorption limit amount, the adsorbed ammonia sometimes naturally disassociates. Therefore, in the present embodiment, the ammonia recovery treatment is ended when the amount of ammonia adsorbed at the NOₓ selective reduction catalyst 50 becomes the maximum value of the adsorption amount of ammonia at which natural disassociation of the ammonia adsorbed at the NOₓ selective reduction catalyst 50 can be suppressed (hereinafter, referred to as the “maximum allowable adsorption amount”) during the ammonia recovery treatment. After that, the control parameters of the internal combustion engine are controlled so that the ratio of NOₓ flowing into the NOₓ selective reduction catalyst 50 becomes higher than the complete purifying ratio.

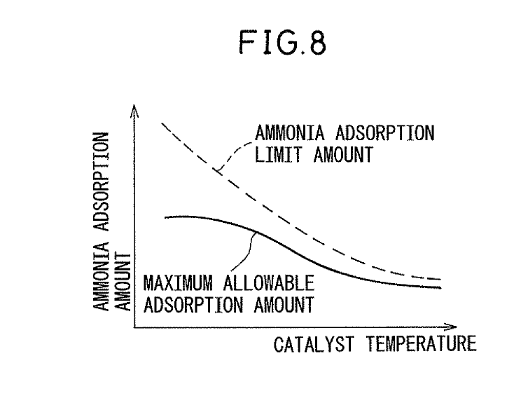

FIG. 8 is a view showing the relationship between the temperature of the NOₓ selective reduction catalyst 50 and the ammonia adsorption amount. As shown in FIG. 8, the maximum allowable adsorption amount is increased as the temperature of the NOₓ selective reduction catalyst 50 becomes lower. Therefore, in the present embodiment, the temperature of the NOₓ selective reduction catalyst 50 is detected by the temperature sensor 23 at the time of start of the ammonia recovery treatment or during the execution thereof, the maximum allowable adsorption amount is calculated by using a map such as shown in FIG. 7 based on the detected temperature, and the ammonia recovery treatment is ended at the time when the amount of ammonia adsorbed at the NOₓ selective reduction catalyst 50 becomes the calculated maximum allowable adsorption amount or more.

Note that, in the present embodiment as well, in the same way as the above embodiment, in order to suppress outflow of the unburned ammonia and NOₓ from the NOₓ selective reduction catalyst 50, control is performed so that the flow rate of NOₓ flowing into the NOₓ selective reduction catalyst 50 becomes the maximum purifiable NOₓ amount, or the temperature of the NOₓ selective reduction catalyst 50 is controlled so that the flow rate of NOₓ flowing into the NOₓ selective reduction catalyst 50 becomes not more than the maximum purifiable NOₓ amount.

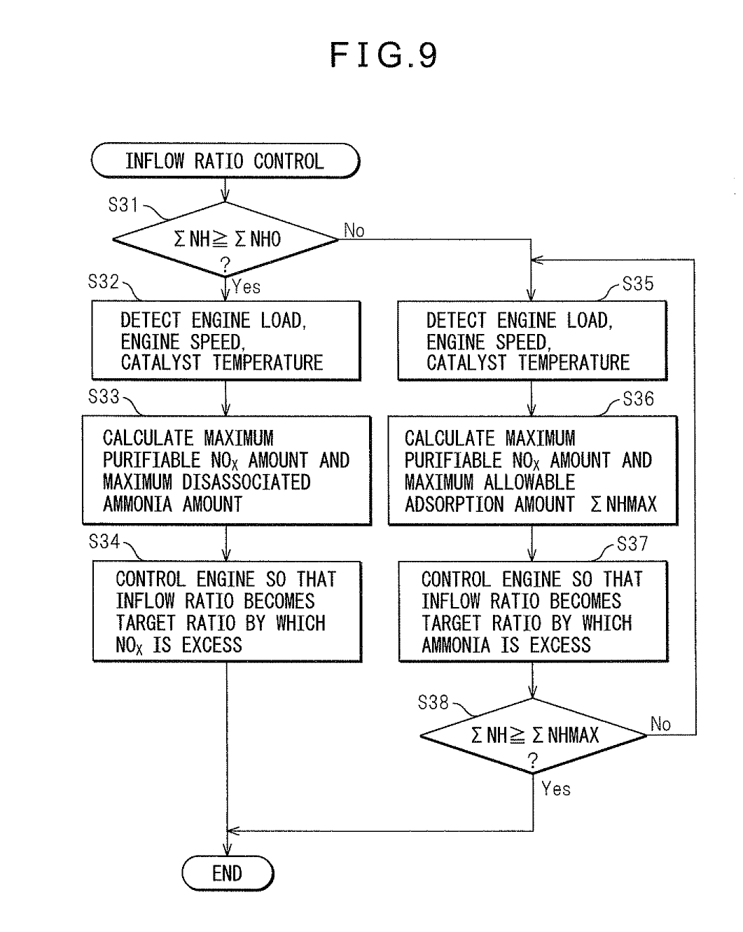

FIG. 9 is a flowchart schematically showing a control routine of the inflow ratio control for controlling the ratio of NOₓ and ammonia flowing into the NOₓ selective reduction catalyst 50 in the present embodiment.

As shown in FIG. 9, first, at step S31, it is determined whether an ammonia adsorption amount ΣNH at the NOₓ selective reduction catalyst 50 is the minimum reference amount ΣNH0or more. Here, the adsorption amount ΣNH of ammonia at the NOₓ selective reduction catalyst 50 is estimated based on for example various types of parameters of the internal combustion engine or calculated based on the output of the NOₓ sensor (not shown) etc. provided at an upstream side of the NOₓ selective reduction catalyst 50. When it is determined that the adsorption amount ΣNH of ammonia at the NOₓ selective reduction catalyst 50 is the minimum reference amount ΣNH0or more, the routine proceeds to step S32.

At step S32, in the same way as step S11 of FIG. 5, the engine load, engine speed, and catalyst temperature are detected. Next, at step S33, in the same way as step S12 of FIG. 5, the maximum purifiable NOₓ amount is calculated, and the maximum disassociated ammonia amount is calculated based on the temperature, etc., of the NOₓ selective reduction catalyst 50 detected at step S32. Next, at step S34, based on the engine load, engine speed, etc., detected at step S32, control parameters of the internal combustion engine are calculated so that the ratio of NOₓ and the unburned ammonia flowing into the NOₓ selective reduction catalyst 50 becomes a ratio by which NOₓ is excessive. At this time, the ratio of NOₓ and the unburned ammonia or the flow rates of NOₓ and the unburned ammonia are set so that the flow rate of NOₓ flowing into the NOₓ selective reduction catalyst 50 becomes not more than the maximum purifiable NOₓ amount and the flow rate of the excess NOₓ which was not purified by the unburned ammonia in the exhaust gas flowing into the NOₓ selective reduction catalyst 50 becomes not more than the maximum disassociated ammonia amount.

On the other hand, when the amount of ammonia adsorbed at the NOₓ selective reduction catalyst 50 is reduced and it is determined at step S31 that the adsorption amount ΣNH of ammonia at the NOₓ selective reduction catalyst 50 is smaller than the minimum reference amount ΣNH0, the routine proceeds to step S35. At step S35, the same control as that at step S32 is carried out. Next, at step S36, in the same way as step S33, the maximum purifiable NOₓ amount is calculated, and the maximum allowable adsorption amount ΣNHMAX is calculated by using the map as shown in FIG. 8 based on the temperature of the NOₓ selective reduction catalyst 50 detected at step S35.

Next, at step S37, based on the engine load, engine speed, etc., detected at step S35, the control parameters of the internal combustion engine are controlled so that the ratio of NOₓ and unburned ammonia flowing into the NOₓ selective reduction catalyst 50 becomes a ratio by which ammonia is excessive (ammonia recovery treatment). At this time, the ratio of NOₓ and ammonia or the flow rates of NOₓ and unburned ammonia are set so that the flow rate of NOₓ flowing into the NOₓ selective reduction catalyst 50 becomes not more than the maximum purifiable NOₓ amount. Next, at step S38, it is determined whether the adsorption amount ΣNH of ammonia to the NOₓ selective reduction catalyst 50 is the maximum allowable adsorption amount ΣNHMAX or more. When it is determined at step S38 that the adsorption amount ΣNH of ammonia to the NOₓ selective reduction catalyst 50 is smaller than the maximum allowable adsorption amount ΣNHMAX, steps S35 to S37 are repeated. On the other hand, when it is determined at step S38 that the adsorption amount ΣNH of ammonia at the NOₓ selective reduction catalyst 50 is the maximum allowable adsorption amount ΣNHMAX or more, the control routine is ended.

Next, an ammonia burning internal combustion engine of a third embodiment of the present invention will be explained. The configuration of the internal combustion engine of the present embodiment is similar to the configuration of the internal combustion engine of the second embodiment. Explanations of similar configurations will be omitted.

In the above second embodiment, at the time of normal running, the excessive NOₓ is purified by the ammonia adsorbed at the NOₓ selective reduction catalyst 50 by controlling the ratio of NOₓ and unburned ammonia in the exhaust gas flowing into the NOₓ selective reduction catalyst 50 to a ratio by which NOₓ is excessive. Next, when the amount of ammonia adsorbed at the NOₓ selective reduction catalyst 50 becomes smaller, the ammonia is adsorbed at the NOₓ selective reduction catalyst 50 by controlling the ratio of NOₓ and unburned ammonia in the exhaust gas flowing into the NOₓ selective reduction catalyst 50 to a ratio by which the ammonia is excessive (the ammonia recovery treatment).

Contrary to this, in the present embodiment, at the time of normal running, the ammonia is adsorbed at the NOₓ selective reduction catalyst 50 by controlling the ratio of NOₓ and unburned ammonia in the exhaust gas flowing into the NOₓ selective reduction catalyst 50 to a ratio by which the ammonia is excessive. Next, when the amount of ammonia adsorbed at the NOₓ selective reduction catalyst 50 becomes larger, the ammonia adsorbed at the NOₓ selective reduction catalyst 50 is oxidized and purified by controlling the ratio of NOₓ and unburned ammonia in the exhaust gas flowing into the NOₓ selective reduction catalyst 50 to a ratio by which NOₓ is excessive.

Namely, in the present embodiment, at the time of normal running of the internal combustion engine, the control parameters of the internal combustion engine are controlled so that the ratio of the unburned ammonia in the exhaust gas flowing into the NOₓ selective reduction catalyst 50 becomes higher than the complete purifying ratio. In other words, in the present embodiment, the ratio of NOₓ and unburned ammonia flowing into the NOₓ selective reduction catalyst 50 is controlled to a ratio by which the unburned ammonia becomes larger than the ratio by which the unburned ammonia in the exhaust gas flowing into the NOₓ selective reduction catalyst 50 is purified exactly enough by NOₓ in the exhaust gas. Due to this, NOₓ in the exhaust gas flowing into the NOₓ selective reduction catalyst 50 is all reduced by the unburned ammonia in the exhaust gas flowing into the NOₓ selective reduction catalyst 50, and the unburned ammonia which does not react with NOₓ, but remains is adsorbed at the NOₓ selective reduction catalyst 50.

Further, when controlling the ratio of NOₓ and unburned ammonia in the exhaust gas flowing into the NOₓ selective reduction catalyst 50 in this way, the amount of ammonia adsorbed at the NOₓ selective reduction catalyst 50 gradually increases. However, as explained above, the amount of ammonia which can be adsorbed at the NOₓ selective reduction catalyst 50 is limited. Therefore, in the present embodiment, when the amount of ammonia adsorbed at the NOₓ selective reduction catalyst 50 becomes the maximum allowable adsorption amount or more, in order to reduce the amount of ammonia adsorbed at the NOₓ selective reduction catalyst 50, ammonia disassociation treatment making the ratio of NOₓ in the exhaust gas flowing into the NOₓ selective reduction catalyst 50 higher than the complete purifying ratio is executed. Due to this, the ammonia adsorbed at the NOₓ selective reduction catalyst 50 can be oxidized and purified by the excess NOₓ contained in the exhaust gas flowing into the NOₓ selective reduction catalyst 50, and accordingly the ammonia adsorption capability of the NOₓ selective reduction catalyst 50 can be restored.

Note that, even when the ammonia disassociation treatment is executed, in the same way as the above second embodiment, in order to suppress excessive flowing of NOₓ into the NOₓ selective reduction catalyst 50 making purifying of NOₓ impossible even by the ammonia adsorbed at the NOₓ selective reduction catalyst 50, the ratio of NOₓ and the unburned ammonia in the exhaust gas flowing into the NOₓ selective reduction catalyst 50 is controlled so that the flow rate of the excessive NOₓ which was not purified by the unburned ammonia in the exhaust gas flowing into the NOₓ selective reduction catalyst 50 becomes the maximum disassociated ammonia amount or less.

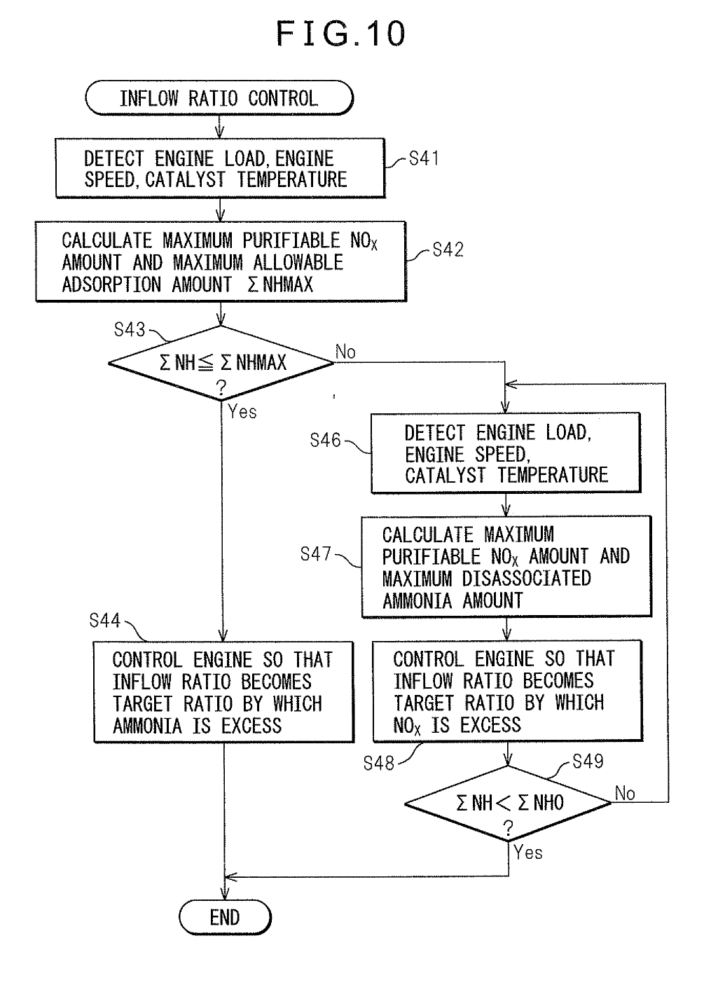

FIG. 10 is a flowchart schematically showing a control routine of the inflow ratio control for controlling the ratio of NOₓ and ammonia flowing into the NOₓ selective reduction catalyst 50 in the present embodiment.

As shown in FIG. 10, first, at step S41, in the same way as step S11 of FIG. 5, the engine load, engine speed, and catalyst temperature are detected. Next, at step S42, in the same way as step S12 of FIG. 5, the maximum purifiable NOₓ amount is calculated, and the maximum allowable adsorption amount ΣNHMAX is calculated by using the map as shown in FIG. 8 based on the temperature of the NOₓ selective reduction catalyst 50 detected at step S41.

Next, at step S43, it is determined whether the adsorption amount ΣNH of ammonia at the NOₓ selective reduction catalyst 50 is the maximum allowable adsorption amount ΣNHMAX or less. When it is determined at step S43 that the adsorption amount ΣNH of ammonia is the maximum allowable adsorption amount ΣNHMAX or less, the routine proceeds to step S44. At step S44, based on the engine load, engine speed, etc., detected at step S41, the control parameters of the internal combustion engine are controlled so that the ratio of NOₓ and unburned ammonia flowing into the NOₓ selective reduction catalyst 50 becomes a ratio by which ammonia is excessive. At this time, the ratio of NOₓ and ammonia or flow rates of NOₓ and ammonia are set so that the flow rate of NOₓ flowing into the NOₓ selective reduction catalyst 50 becomes not more than the maximum purifiable NOₓ amount.

On the other hand, when it is determined at step S43 that the adsorption amount ΣNH of ammonia at the NOₓ selective reduction catalyst 50 is larger than the maximum allowable adsorption amount ΣNHMAX, the routine proceeds to step S46. At step S46, the engine load, etc., are detected in the same way as step S41. Next, at step S47, the maximum purifiable NOₓ amount is calculated in the same way as step S42, and the maximum disassociated ammonia amount is calculated based on the temperature, etc., of the NOₓ selective reduction catalyst 50 detected at step S46. Next, at step S48, based on the engine load, engine speed, etc., detected at step S46, the control parameters of the internal combustion engine are controlled so that the ratio of NOₓ and unburned ammonia flowing into the NOₓ selective reduction catalyst 50 becomes a ratio by which NOₓ is excessive. At this time, the ratio of NOₓ and unburned ammonia or flow rates of NOₓ and unburned ammonia are set so that the flow rate of NOₓ flowing into the NOₓ selective reduction catalyst 50 becomes the maximum purifiable NOₓ amount or less and the flow rate of the excess NOₓ which was not purified by the unburned ammonia in the exhaust gas flowing into the NOₓ selective reduction catalyst 50 becomes the maximum disassociated ammonia amount or less.

Next, at step S49, it is determined whether the adsorption amount ΣNH of ammonia at the NOₓ selective reduction catalyst 50 becomes smaller than a predetermined value ΣNH0 close to 0. When it is determined that the adsorption amount ΣNH of ammonia to the NOₓ selective reduction catalyst 50 is the predetermined amount ΣNH0 or more, steps S46 to S48 are repeated. On the other hand, when it is determined at step S49 that the adsorption amount ΣNH of ammonia at the NOₓ selective reduction catalyst 50 is smaller than the predetermined amount ΣNH0, the control routine is ended.

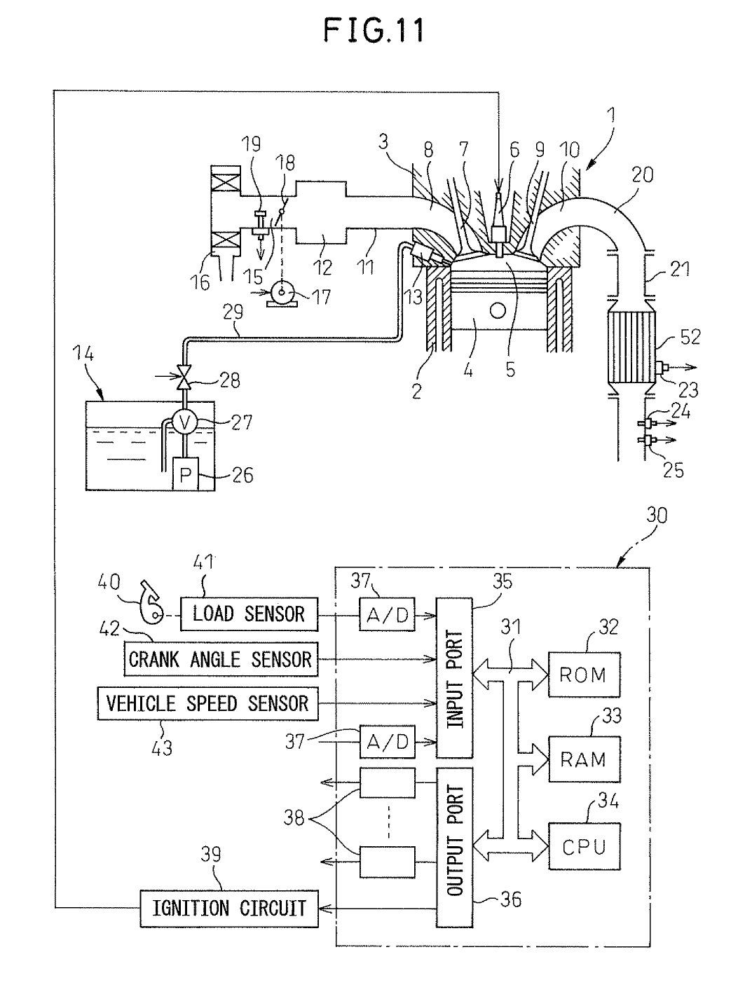

Next, an ammonia burning internal combustion engine of a fourth embodiment of the present invention will be explained with reference to FIG. 11. The configuration of the internal combustion engine of the present embodiment shown in FIG. 11 is basically the same as the configuration of the internal combustion engine of the first embodiment. Explanations of similar configurations will be omitted.

In the ammonia burning internal combustion engine of the fourth embodiment shown in FIG. 11, an NOₓ storage reduction catalyst 52 is provided as the exhaust purifying catalyst 22 of the first embodiment described above. The NOₓ storage reduction catalyst 52 is a catalyst which stores NOₓ in the inflowing exhaust gas when the air-fuel ratio of the inflowing exhaust gas is lean, and makes the stored NOₓ disassociate when the oxygen concentration in the inflowing exhaust gas is low to reduce the NOₓ by the unburned ammonia in the exhaust gas.

When such an NOₓ storage reduction catalyst 52 is used, by performing control inverse to the control in the second embodiment and third embodiment using the NOₓ selective reduction catalyst as the exhaust purifying catalyst, NOₓ and unburned ammonia in the exhaust gas can be suitably purified. In the following description, a case where control inverse to the control in the third embodiment is carried out will be explained.

In the present embodiment, at the time of normal running of the internal combustion engine, the ratio of NOₓ and unburned ammonia flowing into the NOₓ storage reduction catalyst 52 is controlled so that the ratio of NOₓ flowing into the NOₓ storage reduction catalyst 52 becomes higher than the complete purifying ratio. In other words, in the present embodiment, the ratio of NOₓ and unburned ammonia flowing into the NOₓ storage reduction catalyst 52 is controlled to a ratio by which NOₓ becomes larger than the ratio by which NOₓ in the exhaust gas flowing into the NOₓ storage reduction catalyst 52 is purified exactly enough by the unburned ammonia in the exhaust gas. Due to this, the unburned ammonia in the exhaust gas flowing into the NOₓ storage reduction catalyst 52 is all oxidized by NOₓ in the exhaust gas flowing into the NOₓ storage reduction catalyst 52, and NOₓ which does not react with the ammonia, but remains is stored into the NOₓ storage reduction catalyst 52.

Further, if the ratio of NOₓ and unburned ammonia in the exhaust gas flowing into the NOₓ storage reduction catalyst 52 is controlled in this way, the NOₓ storage amount at the NOₓ storage reduction catalyst 52 gradually increases. However, the amount of NOₓ which can be stored at the NOₓ storage reduction catalyst 52 is limited. Therefore, in the present embodiment, at the time when the NOₓ storage amount at the NOₓ storage reduction catalyst 52 becomes the maximum allowable storage amount (the maximum amount of NOₓ which can be stored into the NOₓ storage reduction catalyst 52 without natural outflow of NOₓ) or more, in order to reduce the NOₓ storage amount stored at the NOₓ storage reduction catalyst 52, NOₓ disassociation treatment making the ratio of the unburned ammonia in the exhaust gas flowing into the NOₓ storage reduction catalyst 52 higher than the complete purifying ratio is carried out. Due to this, NOₓ stored in the NOₓ storage reduction catalyst 52 can be reduced and purified by the excess unburned ammonia contained in the exhaust gas flowing into the NOₓ storage reduction catalyst 52, and accordingly the NOₓ storage capability of the NOₓ storage reduction catalyst 52 can be restored.

Note that, even in a case where the NOₓ storage reduction catalyst 52 is used, in the same way as the above first embodiment to third embodiment, in order to suppress outflow of the ammonia and NOₓ from the NOₓ storage reduction catalyst 52, control is performed so that the flow rate of the unburned ammonia flowing into the NOₓ storage reduction catalyst 52 becomes not more than the maximum purifiable ammonia amount, or the temperature of the NOₓ storage reduction catalyst 52 is controlled so that the flow rate of the unburned ammonia flowing into the NOₓ storage reduction catalyst 52 becomes the maximum purifiable ammonia amount or less.

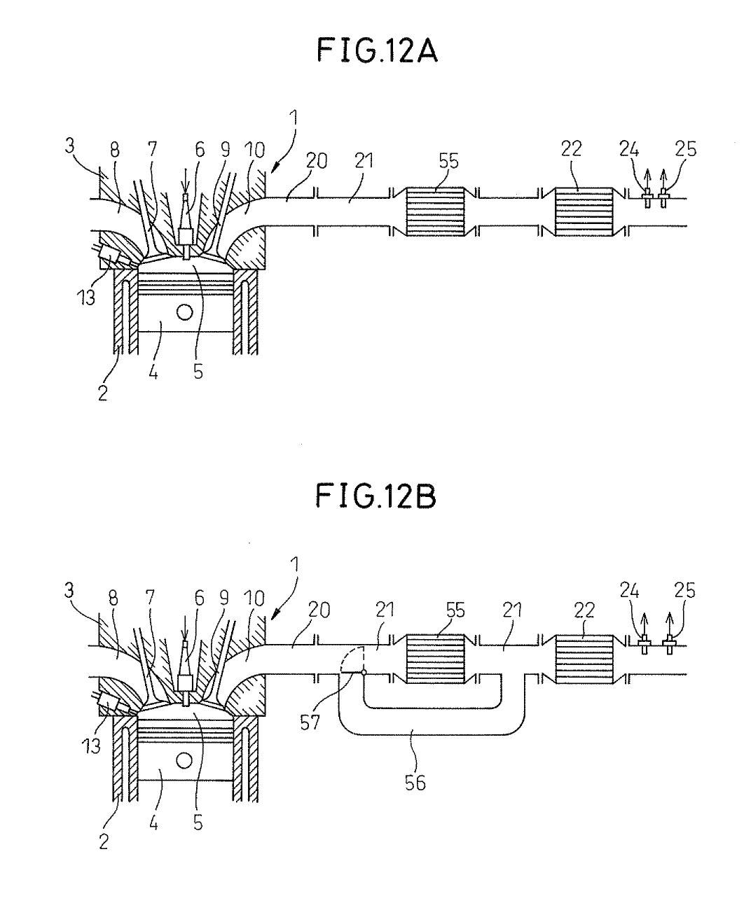

Next, an ammonia burning internal combustion engine of a fifth embodiment of the present invention will be explained with reference to FIGS. 12A and 12B. The configuration of the internal combustion engine of the present embodiment shown in FIGS. 12A and 12B is basically the same as the configuration of the internal combustion engine of the first embodiment. Explanations of similar configurations will be omitted.

FIG. 12A is a view schematically showing an exhaust system of the ammonia burning internal combustion engine of the fifth embodiment. As shown in FIG. 12A, in the ammonia burning internal combustion engine of the present embodiment, an oxidation catalyst 55 is provided at an upstream side of the exhaust purifying catalyst 22 of the first embodiment described above. As the oxidation catalyst 55, use may be made of any catalyst, for example, a three-way catalyst, so far as the unburned ammonia in the inflowing exhaust gas can be oxidized to NOₓ.

In the ammonia burning internal combustion engine of the present embodiment configured in this way, the exhaust gas exhausted from the combustion chamber 5 first flows into the oxidation catalyst 55. A portion of the unburned ammonia in the exhaust gas flowing into the oxidation catalyst 55 is oxidized to NOₓ in the oxidation catalyst 55. Accordingly, in the exhaust gas flowing into the exhaust purifying catalyst 22, in addition to the NOₓ in the exhaust gas exhausted from the combustion chamber 5, NOₓ generated in the oxidation catalyst 55 is contained. On the other hand, in the exhaust gas flowing into the exhaust purifying catalyst 22, an amount of ammonia obtained by subtracting the ammonia oxidized in the oxidation catalyst 55 from the unburned ammonia in the exhaust gas exhausted from the combustion chamber 5 is contained.

In this way, according to the present embodiment, by providing the oxidation catalyst 55 at an upstream side of the exhaust purifying catalyst 22, the ratio of NOₓ with respect to the unburned ammonia in the exhaust gas flowing into the exhaust purifying catalyst 22 can be raised with respect to the ratio of NOₓ in the exhaust gas exhausted from the combustion chamber 5. Due to this, for example, even in a case of trying to control the ratio of NOₓ and unburned ammonia in the exhaust gas flowing into the exhaust purifying catalyst 22 to the complete purifying ratio, the ratio of the unburned ammonia with respect to the NOₓ in the exhaust gas exhausted from the combustion chamber 5 can be made higher than the complete purifying ratio.

Next, a first modification of the fifth embodiment will be explained with reference to FIG. 12B. As shown in FIG. 12B, the ammonia burning internal combustion engine of the present modification is provided with a bypass pipe (bypass passage) 56 which is branched from the exhaust pipe 21 and bypasses the oxidation catalyst 55 and a flow rate control valve 57 provided in a branch portion of the bypass pipe 56 from the exhaust pipe 21. The bypass pipe 56 joins with the exhaust pipe 21 at a downstream side of the oxidation catalyst 55 and at an upstream side of the exhaust purifying catalyst 22. Further, the flow rate control valve 57 can control the flow rate of the exhaust gas flowing into the oxidation catalyst 55 and the bypass pipe 56.

In the ammonia burning internal combustion engine configured in this way, by controlling the flow rate control valve 57, the ratio of NOₓ and unburned ammonia in the exhaust gas flowing into the exhaust purifying catalyst 22 can be controlled. Namely, when the exhaust gas exhausted from the combustion chamber 5 is not made to flow into the bypass pipe 56, but is made to flow into the oxidation catalyst 55, a portion of the unburned ammonia in the exhaust gas is oxidized and becomes NOₓ as explained above. For this reason, the ratio of NOₓ in the exhaust gas flowing into the exhaust purifying catalyst 22 becomes higher. On the other hand, when the exhaust gas exhausted from the combustion chamber 5 is made to flow into the bypass pipe 56, the unburned ammonia is not oxidized to NOₓ, but flows into the exhaust purifying catalyst 22 as it is. For this reason, the ratio of the unburned ammonia in the exhaust gas flowing into the exhaust purifying catalyst 22 is high.

Therefore, in the present modification, by suitably controlling the flow rate of the exhaust gas flowing into the exhaust purifying catalyst 22 and the flow rate of the exhaust gas flowing into the bypass pipe 56 by the flow rate control valve 57, the ratio of NOₓ and unburned ammonia in the exhaust gas flowing into the exhaust purifying catalyst 22 is made to become the target ratio (for example, complete purifying ratio). Namely, when the ratio of NOₓ in the exhaust gas flowing into the exhaust purifying catalyst 22 is higher than the target ratio and accordingly when it is necessary to make the ratio of the unburned ammonia in the exhaust gas flowing into the exhaust purifying catalyst 22 higher, the flow rate of the exhaust gas flowing into the oxidation catalyst 55 is reduced and the flow rate of the exhaust gas flowing into the bypass pipe 56 is increased. Conversely, when the ratio of the unburned ammonia in the exhaust gas flowing into the exhaust purifying catalyst 22 is higher than the target ratio and accordingly when it is necessary to make the ratio of NOₓ in the exhaust gas flowing into the exhaust purifying catalyst 22 higher, the flow rate of the exhaust gas flowing into the oxidation catalyst 55 is increased, and the flow rate of the exhaust gas flowing into the bypass pipe 56 is reduced. Due to this, the ratio of NOx and unburned ammonia in the exhaust gas flowing into the exhaust purifying catalyst 22 can be made to match with the target ratio.

Note that, in the present embodiment, in addition to the control of the ratio of NOₓ and unburned ammonia in the exhaust gas flowing into the exhaust purifying catalyst 22 by the flow rate control valve 57, as shown in the first embodiment, etc., described above, by controlling the ignition timing and fuel injection timing, etc., of the internal combustion engine, the ratio of NOₓ and unburned ammonia in the exhaust gas flowing into the exhaust purifying catalyst 22 may be controlled as well. In this case, the ratio of NOₓ and unburned ammonia in the exhaust gas exhausted from the combustion chamber 5 is controlled so that the ratio of the ammonia becomes higher than the target ratio, so that the ratio of NOₓ and unburned ammonia in the exhaust gas flowing into the exhaust purifying catalyst 22 can be controlled by the flow rate control valve 57.

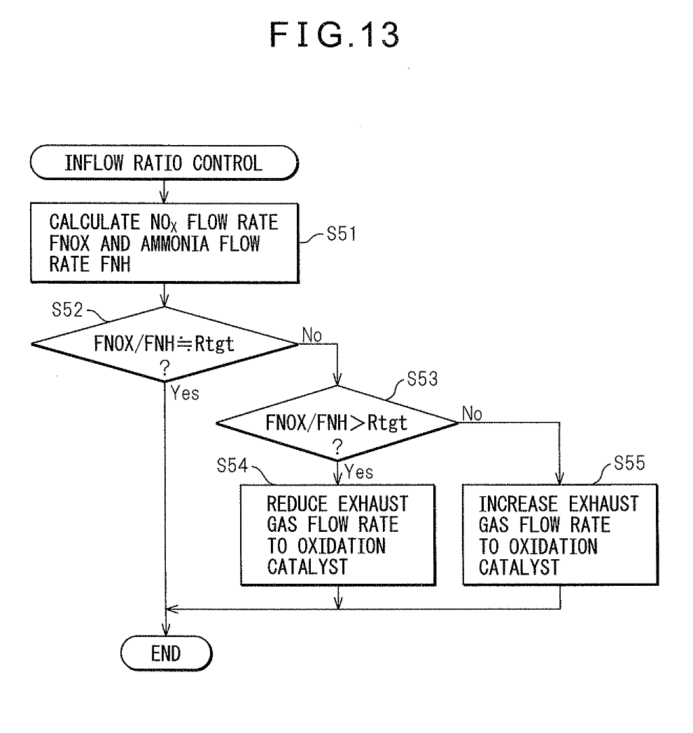

FIG. 13 is a flowchart showing a control routine of the inflow ratio control for controlling the ratio of NOₓ and ammonia flowing into the exhaust purifying catalyst 22 in the first modification of the fifth embodiment. As shown in FIG. 13, first, at step S51, a flow rate FNOX of NOₓ and a flow rate FNH of the ammonia in the exhaust gas flowing into the exhaust purifying catalyst 22 are calculated. The flow rate FNOX of NOₓ and flow rate FNH of ammonia may be calculated based on the NOₓ sensor and ammonia sensor (not shown) provided at a downstream side of the confluence part of the bypass pipe 56 and at an upstream side of the exhaust purifying catalyst 22 or may be calculated based on the running state of the internal combustion engine (for example, ignition timing, fuel injection timing, and operation position of the flow rate control valve 57, etc.)

Next, at step S52, it is determined whether a ratio FNOX/FNH of NOₓ and ammonia in the exhaust gas flowing into the exhaust purifying catalyst 22, which was calculated based on the flow rate FNOX of NOₓ and flow rate FNH of ammonia at step S51, is substantially the same as a target ratio Rtgt. When it is determined at step S52 that the ratio FNOX/FNH of NOₓ and ammonia in the exhaust gas flowing into the exhaust purifying catalyst 22 is substantially the same as the target ratio Rtgt, the flow rate control valve 57 is maintained as it is and the control routine is ended.

On the other hand, when it is determined at step S52 that the ratio FNOX/FNH of NOₓ and ammonia in the exhaust gas flowing into the exhaust purifying catalyst 22 is not the same as the target ratio Rtgt, the routine proceeds to step S53. At step S53, it is determined whether the ratio FNOX/FNH of NOₓ and ammonia is higher than the target ratio Rtgt. When it is determined at step S53 that the ratio FNOX/FNH of NOₓ and ammonia is higher than the target ratio Rtgt, that is, when it is determined that the ratio of NOₓ is higher, the routine proceeds to step S54. At step S54, the flow rate control valve 57 is controlled so that the flow rate of the exhaust gas flowing into the oxidation catalyst 55 is reduced. On the other hand, when it is determined at step S53 that the ratio FNOX/FNH of NOₓ and ammonia is lower than the target ratio, that is, when it is determined that the ratio of the ammonia is higher, the routine proceeds to step S55. At step S55, the flow rate control valve 57 is controlled so that the flow rate of the exhaust gas flowing into the oxidation catalyst 55 increases.

Next, a second modification of the fifth embodiment will be explained. The configuration of the ammonia burning internal combustion engine in the present modification is basically the same as the configuration in the first modification.

In this regard, as explained above, the purifying capability of ammonia and NOₓ by the exhaust purifying catalyst 22 is limited. For example, when an NOₓ selective reduction catalyst is used as the exhaust purifying catalyst 22, if the flow rate of NOₓ flowing into the exhaust purifying catalyst 22 exceeds the maximum purifiable NOₓ amount, a portion of NOₓ flowing into the exhaust purifying catalyst 22 is not purified by the exhaust purifying catalyst 22, but flows out downstream of the exhaust purifying catalyst 22.

Here, as explained above, when the exhaust gas exhausted from the combustion chamber 5 is made to flow into the oxidation catalyst 55, a portion of the unburned ammonia in the exhaust gas flowing into the oxidation catalyst 55 is oxidized to NOₓ. For this reason, if the exhaust gas is made to flow into the oxidation catalyst 55 in a case where the flow rate of NOₓ in the exhaust gas exhausted from the combustion chamber 5 is larger than the maximum purifiable NOₓ amount of the exhaust purifying catalyst 22 or a case where it is slightly smaller than the maximum purifiable NOₓ amount, the unburned ammonia is oxidized to NOₓ in the oxidation catalyst 55, therefore an amount of NOₓ so large that it cannot be purified in the exhaust purifying catalyst 22 per unit time ends up flowing into the exhaust purifying catalyst 22.

Therefore, in the present modification, when at least the flow rate of NOₓ in the exhaust gas exhausted from the combustion chamber 5 is larger than the maximum purifiable NOₓ amount of the exhaust purifying catalyst 22, all exhaust gas is not made to flow into the oxidation catalyst 55, but is made to flow into the bypass pipe 56. Due to this, a flow of NOₓ much larger than the maximum purifiable NOₓ amount into the exhaust purifying catalyst 22 is suppressed, and it becomes possible to purify most of the NOₓ by the exhaust purifying catalyst 22 even in a case where a large amount of NOₓ is exhausted from the combustion chamber 5.

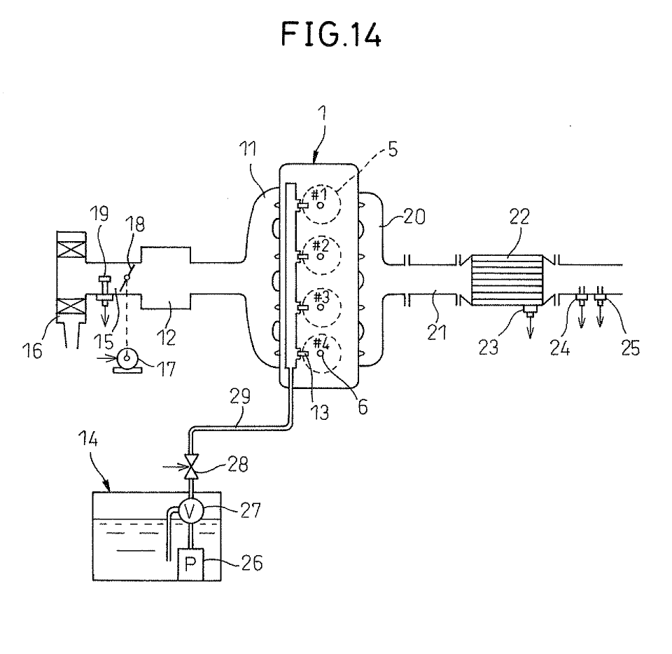

Next, an ammonia burning internal combustion engine of a sixth embodiment of the present invention will be explained with reference to FIG. 14. The configuration of the internal combustion engine of the present embodiment shown in FIG. 14 is basically the same as the configuration of the internal combustion engine of the first embodiment. Explanations of similar configurations will be omitted.

As seen from FIG. 14, the ammonia burning internal combustion engine of the present embodiment is an in-line four-cylinder internal combustion engine. The cylinders of this internal combustion engine are arranged in a line in the order of #1, #2, #3, and #4. Among these, in the present embodiment, the air-fuel ratio of the air-fuel mixture is made rich in the #1 cylinder and #4 cylinder, and the air-fuel ratio of the air-fuel mixture is made lean in the #2 cylinder and #3 cylinder. Namely in the present embodiment, among the plurality of cylinders of the internal combustion engine, the air-fuel ratio of the air-fuel mixture is made rich in part of the cylinders, and the air-fuel ratio of the air-fuel mixture is made lean in the other cylinders.

In general, when the air-fuel ratio of the air-fuel mixture in a cylinder of an internal combustion engine is made rich, a larger amount of unburned ammonia than NOₓ will be contained in the exhaust gas exhausted from the combustion chamber 5. In particular, the higher the degree of richness of the air-fuel ratio of the air-fuel mixture (that is, the lower the air-fuel ratio), the larger the amount of the unburned ammonia contained in the exhaust gas exhausted from the combustion chamber 5. Conversely, when the air-fuel ratio of the air-fuel mixture in a cylinder of the internal combustion engine is made lean, a larger amount of NOₓ than the unburned ammonia will be contained in the exhaust gas exhausted from the combustion chamber 5.

Accordingly, according to the present embodiment, by suitably adjusting the degree of richness of the air-fuel mixture in the cylinders (#1 cylinder and #4 cylinder) in which the air-fuel ratio of the air-fuel mixture becomes rich and the degree of leanness of the air-fuel mixture in the cylinders (#2 cylinder and #3 cylinder) in which the air-fuel ratio of the air-fuel mixture becomes lean, the ratio of NOₓ and unburned ammonia in the exhaust gas flowing into the exhaust purifying catalyst 22 can be controlled to the target ratio (for example, complete purifying ratio).

Specifically, when the ratio of NOₓ in the exhaust gas flowing into the exhaust purifying catalyst 22 is higher than the target ratio, that is, when the ratio of the unburned ammonia in the exhaust gas flowing into the exhaust purifying catalyst 22 should be made higher, the degree of richness of the air-fuel mixture in the #1 cylinder and #4 cylinder is made higher and the degree of leanness of the air-fuel mixture in the #2 cylinder and #3 cylinder is made lower. On the other hand, when the ratio of the unburned ammonia in the exhaust gas flowing into the exhaust purifying catalyst 22 is higher than the target ratio, that is, when the ratio of NOₓ in the exhaust gas flowing into the exhaust purifying catalyst 22 should be made higher, the degree of richness of the air-fuel mixture in the #1 cylinder and #4 cylinder is made lower and the degree of leanness of the air-fuel mixture in the #2 cylinder and #3 cylinder is made higher.

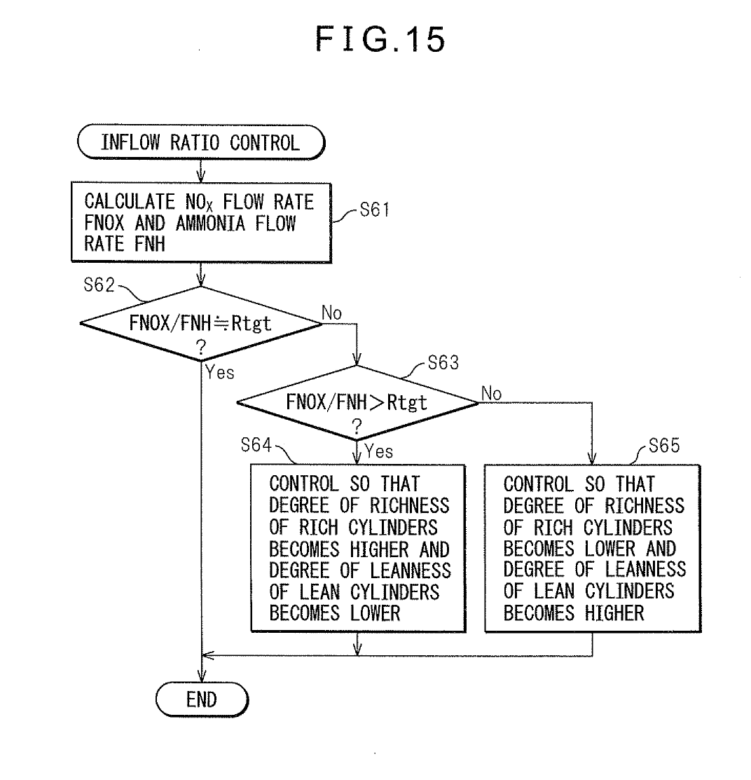

FIG. 15 is a flowchart showing a control routine of the inflow ratio control controlling the ratio of NOₓ and ammonia flowing into the exhaust purifying catalyst 22 in the sixth embodiment. Steps S61 to S63 in FIG. 15 are same as steps S51 to S53 in FIG. 13, therefore an explanation will be omitted. At step S63, when it is determined that the ratio FNOX/FNH of NOₓ and ammonia is higher than the target ratio Rtgt, that is, when it is determined that the ratio of NOₓ is higher, the routine proceeds to step S64. At step S64, the degree of richness of the air-fuel mixture in cylinders in which the air-fuel ratio of the air-fuel mixture becomes rich is made higher and the degree of leanness of the air-fuel mixture in cylinders in which the air-fuel ratio of the air-fuel mixture becomes lean is made lower. On the other hand, when it is determined at step S63 that the ratio FNOX/FNH of NOₓ and ammonia is lower than the target ratio, that is, when it is determined that the ratio of ammonia is higher, the routine proceeds to step S65. At step S65, the degree of richness of the air-fuel mixture in cylinders in which the air-fuel ratio of the air-fuel mixture becomes rich is made lower and the degree of leanness of the air-fuel mixture in cylinders in which the air-fuel ratio of the air-fuel mixture becomes lean is made higher.

Note that, in the above embodiment, an in-line four-cylinder internal combustion engine was shown as an example, but an internal combustion engine of any number of cylinders may be employed so far as it is an internal combustion engine having a plurality of cylinders. A V-type internal combustion engine or horizontally opposed type internal combustion engine, etc., may be employed as well.

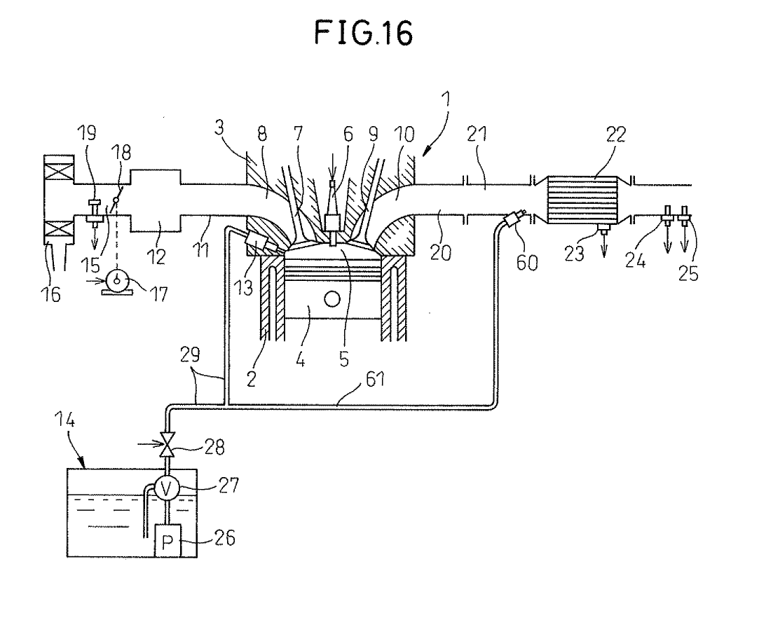

Next, an ammonia burning internal combustion engine of a seventh embodiment of the present invention will be explained with reference to FIG. 16. The configuration of the internal combustion engine of the present embodiment shown in FIG. 16 is basically the same as the configuration of the internal combustion engine of the first embodiment. Explanations of similar configurations will be omitted.

As shown in FIG. 16, in the present embodiment, the exhaust pipe 21 at an upstream side of the exhaust purifying catalyst 22 is provided with an ammonia addition device 60 adding ammonia into the exhaust gas flowing into the exhaust purifying catalyst 22. The ammonia addition device 60 is connected to an addition device feed pipe 61 branched from the ammonia feed pipe 29. In particular, in the embodiment shown in FIG. 16, the ammonia addition device 60 injects liquid ammonia under a high injection pressure toward the exhaust purifying catalyst 22. Due to this, even in a case where only a small amount of liquid ammonia is injected from the ammonia addition device 60, the ammonia can be dispersed in the exhaust gas flowing into the exhaust purifying catalyst 22.

Note that, in an internal combustion engine having an exhaust turbocharger, the ammonia addition device 60 may be provided at a further upstream side of the exhaust turbine to inject the liquid ammonia into the high temperature exhaust gas. In this case, it becomes possible to effectively vaporize the liquid ammonia by heat of the exhaust gas.

In the ammonia burning internal combustion engine configured in this way, by controlling the added amount of ammonia from the ammonia addition device 60, the ratio of NOₓ and unburned ammonia in the exhaust gas flowing into the exhaust purifying catalyst 22 can be controlled. Namely, when the added amount of ammonia from the ammonia addition device 60 is increased, the ratio of ammonia in the exhaust gas flowing into the exhaust purifying catalyst 22 can be made higher. Conversely, when the added amount of ammonia from the ammonia addition device 60 is reduced, the ratio of the ammonia in the exhaust gas flowing into the exhaust purifying catalyst 22 can be made lower.

Therefore, in the present embodiment, by controlling the internal combustion engine so that the ratio of NOₓ in the exhaust gas exhausted from the combustion chamber 5 becomes higher than the target ratio and controlling the added amount of ammonia from the ammonia addition device 60, the ratio of NOₓ and ammonia in the exhaust gas flowing into the exhaust purifying catalyst 22 is made to become the target ratio. Namely, when the ratio of NOₓ in the exhaust gas flowing into the exhaust purifying catalyst 22 is higher than the target ratio and accordingly when it is necessary to make the ratio of the ammonia in the exhaust gas flowing into the exhaust purifying catalyst 22 higher, the added amount of ammonia from the ammonia addition device 60 is increased. Conversely, when the ratio of the ammonia in the exhaust gas flowing into the exhaust purifying catalyst 22 is higher than the target ratio and accordingly when it is necessary to make the ratio of NOₓ in the exhaust gas flowing into the exhaust purifying catalyst 22 higher, the added amount of ammonia from the ammonia addition device 60 is reduced. Due to this, the ratio of the NOₓ and ammonia in the exhaust gas flowing into the exhaust purifying catalyst 22 can be made to match with the target ratio.

Note that, in the present embodiment, the ammonia addition device 60 adds liquid ammonia into the exhaust gas. However, the ammonia addition device 60 may be configured to add gaseous ammonia into the exhaust gas as well. In this case, the addition device feed pipe 61 is connected to an upper portion of the fuel tank 14 so that only the gaseous ammonia in the fuel tank 14 flows into the addition device feed pipe 61. Alternatively, the addition device feed pipe 61 is provided with a vaporizer in order to vaporize the ammonia fed to the ammonia addition device 60. Further, by adding the gaseous ammonia from the ammonia addition device 60 in this way, lowering of the temperature of the exhaust gas flowing into the exhaust purifying catalyst 22 due to latent heat of vaporization of ammonia can be suppressed.

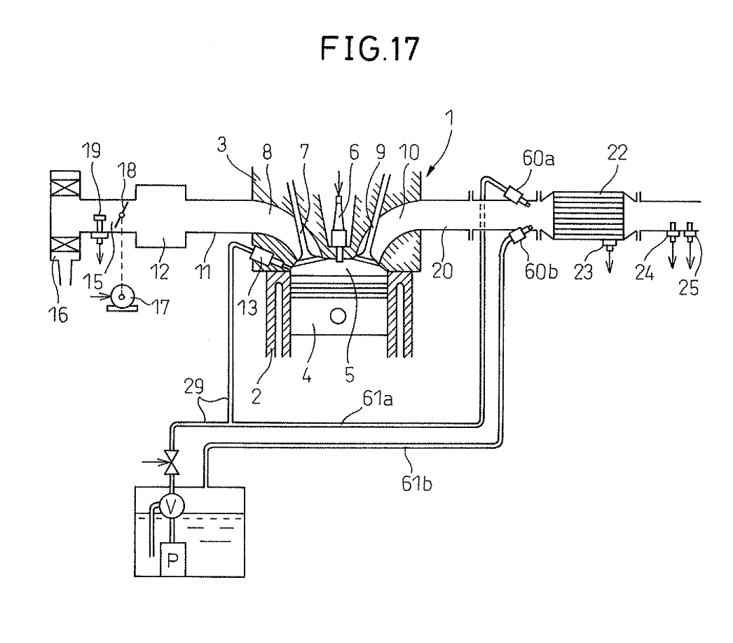

Next, a modification of the seventh embodiment will be explained with reference to FIG. 17. In the modification shown in FIG. 17, two ammonia addition devices adding ammonia into the exhaust gas flowing into the exhaust purifying catalyst 22 are provided. One ammonia addition device 60a can inject liquid ammonia toward the exhaust purifying catalyst 22 (hereinafter, referred to as a “liquid ammonia addition device”) and is connected to an addition device feed pipe 61a branched from the ammonia feed pipe 29. The other ammonia addition device 60b can inject gaseous ammonia toward the exhaust purifying catalyst 22 (hereinafter, referred to as a “gaseous ammonia addition device”) and is connected to an addition device feed pipe 61b connected to the upper portion of the fuel tank 14.

In the ammonia burning internal combustion engine of the present modification configured in this way, in the same way as the ammonia burning internal combustion engine of the seventh embodiment described above, ammonia is added from the ammonia addition devices 60a and 60b so that the ratio of NOₓ and unburned ammonia in the exhaust gas flowing into the exhaust purifying catalyst 22 becomes the target ratio. In the present embodiment, the addition of ammonia into the exhaust gas is basically carried out from the gaseous ammonia addition device 60b so that the temperature of the exhaust purifying catalyst 22 is not lowered to below the activation temperature due to the latent heat of vaporization of the ammonia.

However, for example, when an engine high load running state continues, high temperature exhaust gas ends up continuously flowing into the exhaust purifying catalyst 22. The temperature of the exhaust purifying catalyst 22 rises as well along with this. However, in the exhaust purifying catalyst 22, when the temperature exceeds a catalyst deterioration temperature, deterioration of the catalyst is caused. Therefore, in the present modification, in order to prevent the temperature of the exhaust purifying catalyst 22 from exceeding the catalyst deterioration temperature, when the temperature of the exhaust purifying catalyst 22 becomes higher than the upper limit temperature in the vicinity of the catalyst deterioration temperature, that is, when the temperature of the exhaust purifying catalyst 22 should be lowered, the addition of ammonia into the exhaust gas is carried out from the liquid ammonia addition device 60a. When the addition of ammonia is carried out from the liquid ammonia addition device 60a in this way, due to the latent heat of vaporization of the ammonia added from the liquid ammonia addition device 60a, the temperature of the exhaust gas flowing into the exhaust purifying catalyst 22 is lowered.

In this way, according to the present modification, by switching the ammonia to be added into the exhaust gas from the ammonia addition devices 60a and 60b between a liquid and gas in accordance with the temperature of the exhaust purifying catalyst 22, it becomes possible to maintain the temperature of the exhaust purifying catalyst 22 at a temperature more than the activation temperature and less than the catalyst deterioration temperature.

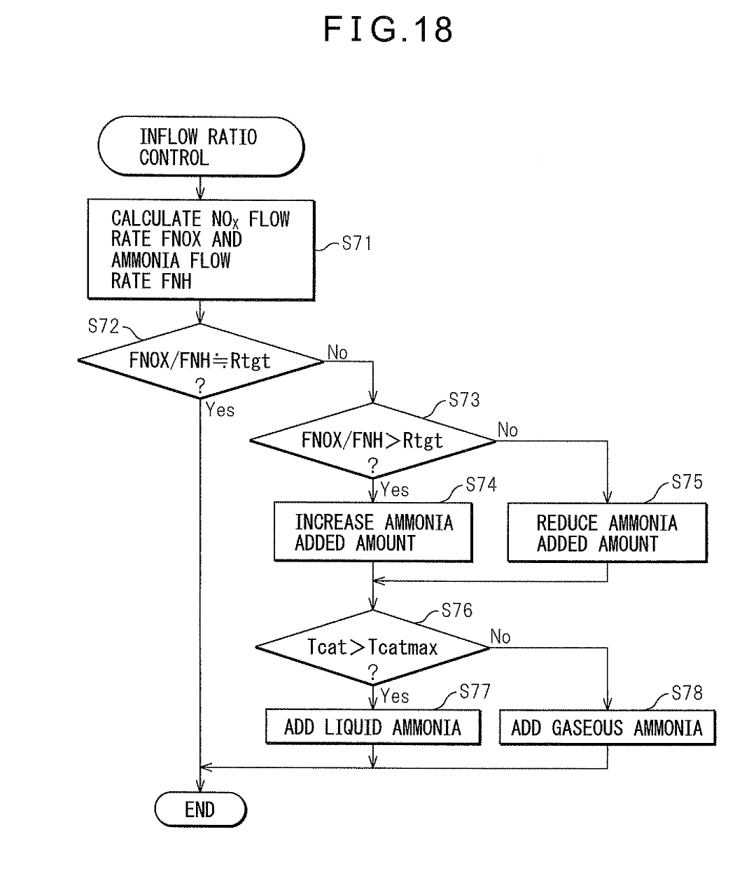

FIG. 18 is a flowchart showing a control routine of the inflow ratio control controlling the ratio of NOₓ and ammonia flowing into the exhaust purifying catalyst 22 in the seventh embodiment. Steps S71 to S73 in FIG. 18 are same as steps S51 to S53 in FIG. 13, therefore an explanation will be omitted. At step S73, when it is determined that the ratio FNOX/FNH of NOₓ and ammonia is higher than the target ratio Rtgt, that is, when it is determined that the ratio of NOₓ is higher, the routine proceeds to step S74. At step S74, the added amount of ammonia from the ammonia addition device 60 is increased. On the other hand, when it is determined at step S73 that the ratio FNOX/FNH of NOₓ and ammonia is lower than the target ratio, that is, when it is determined that the ratio of ammonia is higher, the routine proceeds to step S75. At step S75, the added amount of ammonia from the ammonia addition device 60 is reduced.

Next, at step S76, it is determined whether a temperature Tcat of the exhaust purifying catalyst 22 is higher than the upper limit temperature Tcatmax. When it is determined that the temperature Tcat of the exhaust purifying catalyst 22 is higher than the upper limit temperature Tcatmax, the routine proceeds to step S77. At step S77, ammonia of the amount of addition adjusted at step S74 or S75 is added from the liquid ammonia addition device 60a. On the other hand, when it is determined that the temperature Tcat of the exhaust purifying catalyst 22 is lower than the upper limit temperature Tcatmax, ammonia of the amount of addition adjusted at step S74 or S75 is added from the gaseous ammonia addition device 60b.

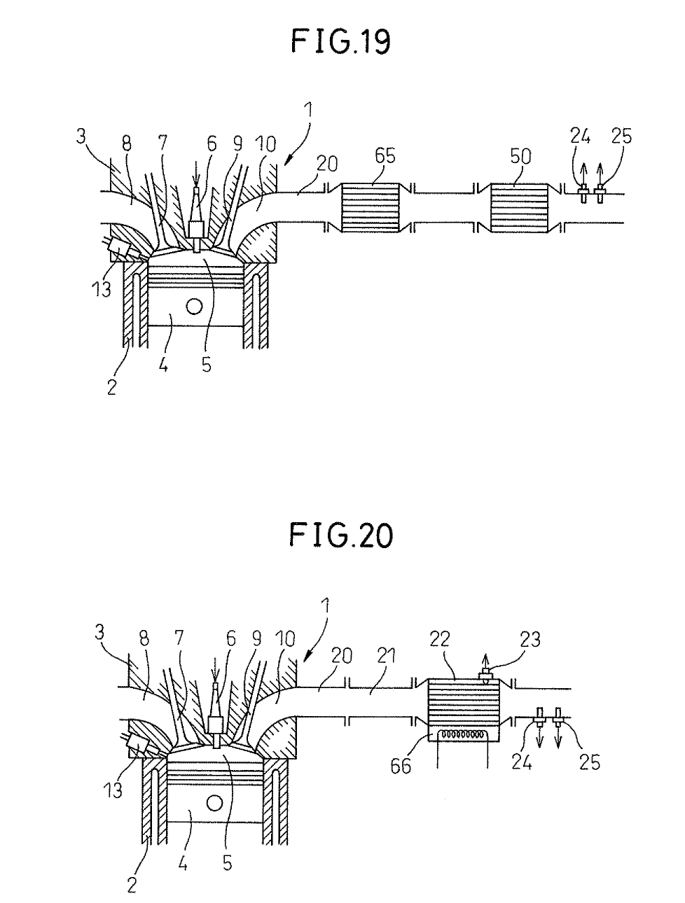

Next, an ammonia burning internal combustion engine of an eighth embodiment of the present invention will be explained with reference to FIG. 19. The configuration of the ammonia burning internal combustion engine of the present embodiment is basically the same as the configuration of the ammonia burning internal combustion engine of the fifth embodiment shown in FIG. 12A. Explanations of similar configurations will be omitted.

As shown in FIG. 19, in the ammonia burning internal combustion engine of the present embodiment, the NOₓ selective reduction catalyst 50 is provided as the exhaust purifying catalyst, and a three-way catalyst 65 is provided at an upstream side of the NOₓ selective reduction catalyst 50. Further, in the internal combustion engine of the present embodiment, at the time of normal running, in order to reduce pumping loss, control is performed so that the air-fuel ratio of the air-fuel mixture becomes lean. Accordingly, in the internal combustion engine of the present embodiment, at the time of normal running, in the same way as the ammonia burning internal combustion engine of the second embodiment described above, control is performed so that the ratio of NOₓ and ammonia in the exhaust gas flowing into the NOₓ selective reduction catalyst 50 (particularly, the ratio of NOₓ and ammonia in the exhaust gas exhausted from the combustion chamber 5 in the present embodiment) becomes a ratio by which NOₓ is larger than the complete purifying ratio.

In this regard, at the time of cold start of the internal combustion engine or the like, the temperature of the NOₓ selective reduction catalyst 50 is low, and the purifying capability of NOₓ and ammonia by the NOₓ selective reduction catalyst 50 is lowered. Even if NOₓ and ammonia flow into the NOₓ selective reduction catalyst 50 under a situation such that the purifying capability of the NOₓ selective reduction catalyst 50 is lowered in this way, these NOₓ and ammonia do not react with each other, but flow out of the NOₓ selective reduction catalyst 50. Accordingly, when the purifying capability of the NOₓ selective reduction catalyst 50 is lowered, it is necessary to prevent NOₓ and ammonia from flowing into the NOₓ selective reduction catalyst 50 as much as possible.

On the other hand, the three-way catalyst 65 is provided at just the downstream side of the exhaust manifold 20. Therefore, even at the time of cold start of the internal combustion engine or the like, the temperature of the three-way catalyst rises soon. Accordingly, while the purifying capability of the NOₓ selective reduction catalyst 50 becomes low for a certain degree of time at the time of cold start of the internal combustion engine, the purifying capability of the three-way catalyst 65 is raised immediately after the start of the internal combustion engine. Therefore, in the present embodiment, at the time when the purifying capability of the NOₓ selective reduction catalyst 50 is lowered such as at the time of cold start of the internal combustion engine, NOₓ and ammonia in the exhaust gas exhausted from the combustion chamber 5 are purified by the three-way catalyst 65.

Specifically, in the internal combustion engine of the present embodiment, while the intake air amount and fuel injection amount, etc., are controlled so that the air-fuel ratio of the air-fuel mixture becomes lean at the time of normal running as explained above, when the purifying capability of the NOₓ selective reduction catalyst 50 is lower than the predetermined purifying capability (for example, when the temperature of the NOₓ selective reduction catalyst 50 is lower than the activation temperature thereof), the intake air amount, fuel injection amount, etc., are controlled so that the air-fuel ratio of the air-fuel mixture becomes the stoichiometric air-fuel ratio. By controlling the air-fuel ratio of the air-fuel mixture to the stoichiometric air-fuel ratio in this way, it becomes easy to purify NOₓ and ammonia in the exhaust gas exhausted from the combustion chamber 5 in the three-way catalyst 65. Accordingly, even at the time when the purifying capability of the NOₓ selective reduction catalyst 50 is low, NOₓ and ammonia in the exhaust gas can be effectively purified.

Alternatively, in the internal combustion engine of the present embodiment, while control is performed so that the ratio of NOₓ and ammonia in the exhaust gas exhausted from the combustion chamber 5 becomes a ratio by which NOₓ is larger than the complete purifying ratio at the time of normal running in the present embodiment as explained above, when the purifying capability of the NOₓ selective reduction catalyst 50 is lower than the predetermined purifying capability, in the present embodiment, the internal combustion engine may be controlled so that the ratio of NOₓ and ammonia in the exhaust gas exhausted from the combustion chamber 5 becomes the complete purifying ratio. In this way, in the present embodiment, by control of the ratio of NOₓ and ammonia in the exhaust gas exhausted from the combustion chamber 5 to the complete purifying ratio, it becomes easy to purify NOₓ and ammonia in the exhaust gas exhausted from the combustion chamber 5 in the three-way catalyst 65. For this reason, even at the time when the purifying capability of the NOₓ selective reduction catalyst 50 is low, NOₓ and ammonia in the exhaust gas can be effectively purified.

Note that, in the above embodiment, the case where control is performed so that the air-fuel ratio of the air-fuel mixture becomes lean and the ratio of NOₓ and ammonia in the exhaust gas exhausted from the combustion chamber 5 becomes a ratio by which NOₓ is larger than the complete purifying ratio at the time of normal running is shown. However, the invention can also be applied to a case where control is performed so that the air-fuel ratio of the air-fuel mixture becomes rich and the ratio of NOₓ and ammonia in the exhaust gas exhausted from the combustion chamber 5 becomes a ratio by which the ammonia is larger than the complete purifying ratio at the time of normal running.

Further, in the present embodiment, the case where the temperature of the NOₓ selective reduction catalyst 50 is low is shown as the time when the purifying capability of the NOₓ selective reduction catalyst 50 is lowered. However, the invention can also be applied to a case where the purifying capability of the NOₓ selective reduction catalyst 50 is lowered due to for example aging.

Further, for example, in a case where the ratio of NOₓ and ammonia in the exhaust gas exhausted from the combustion chamber 5 cannot be suitably controlled due to breakdown of the NOₓ sensor or ammonia sensor, etc., provided in the engine exhaust passage or the like, control may be performed so that the air-fuel ratio of the air-fuel mixture is made the stoichiometric air-fuel ratio. By controlling the air-fuel ratio of the air-fuel mixture to become the stoichiometric air-fuel ratio in this way, even in the case where the ratio of NOₓ and ammonia in the exhaust gas exhausted from the combustion chamber 5 cannot be suitably controlled, it becomes possible to suitably purify both of NOₓ and ammonia in the exhaust gas exhausted from the combustion chamber 5 to a certain extent.

Next, a first modification of the eighth embodiment will be explained. The configuration of the exhaust purifying system in the present modification may be the configuration of the exhaust purifying system of the eighth embodiment as shown in FIG. 19 and also the configuration of another exhaust purifying system as shown in FIG. 1, etc. In the following description, the explanation will be given by taking as an example a case where the present modification is applied to the ammonia burning internal combustion engine shown in FIG. 1.

In this regard, as explained above, when the purifying capability of the exhaust purifying catalyst 22 is lowered such as at the time of cold start of the internal combustion engine, even when NOₓ and ammonia flow into the exhaust purifying catalyst 22, these NOₓ and ammonia are not purified, but flow out of the exhaust purifying catalyst 22. Accordingly, in a case where the purifying capability of the exhaust purifying catalyst 22 is lowered, it is necessary to reduce the flow rates of NOₓ and ammonia flowing into the exhaust purifying catalyst 22.

Here, as shown in FIG. 3, when a non-ammonia fuel is fed into the combustion chamber 5 in addition to ammonia, if the ratio of the non-ammonia fuel in the fuel fed into the combustion chamber 5 (ammonia and non-ammonia fuel) increases, the amount of ammonia fed into the combustion chamber 5 is lowered by that amount. In this way, when the amount of ammonia fed into the combustion chamber 5 is reduced, the amount of the unburned ammonia exhausted from the combustion chamber 5 is reduced along with that, and the amount of generation of NOₓ along with burning of the ammonia in the combustion chamber 5 is reduced, therefore the amount of NOₓ exhausted from the combustion chamber 5 is reduced as well. Accordingly, when the ratio of the non-ammonia fuel in the fuel fed into the combustion chamber 5 increases, the amounts of NOₓ and unburned ammonia exhausted from the combustion chamber 5 are reduced.

Therefore, in the present modification, when the purifying capability of the exhaust purifying catalyst 22 has become lower than a predetermined purifying capability, the ratio of ammonia in fuel fed into the combustion chamber 5 is made lower in comparison with the case where the purifying capability of the exhaust purifying catalyst 22 is higher than the above predetermined purifying capability. Due to this, the amounts of NOₓ and unburned ammonia exhausted from the combustion chamber 5 are reduced. Therefore, even in a case where the purifying capability of the exhaust purifying catalyst 22 is low, outflow of NOₓ and unburned ammonia in large amounts from the exhaust purifying catalyst 22 can be suppressed.

Note that, by combining the present modification and eighth embodiment described above, the internal combustion engine may by controlled so that when the purifying capability of the exhaust purifying catalyst 22 has becomes lower than the predetermined purifying capability, the ratio of the ammonia in fuel fed into the combustion chamber 5 may be lowered and the air-fuel ratio of the air-fuel mixture in the combustion chamber 5 becomes the stoichiometric air-fuel ratio.

Further, in the present modification, the purifying capability of the exhaust purifying catalyst 22 is determined based on the temperature of the exhaust purifying catalyst 22, the degree of deterioration of the exhaust purifying catalyst 22, and so on. For example, in a case where the temperature of the exhaust gas flowing into the exhaust purifying catalyst 22 is lower than the activation temperature thereof or a case where the degree of deterioration of the exhaust purifying catalyst 22 is higher than the predetermined degree of deterioration, it is determined that the purifying capability of the exhaust purifying catalyst 22 is lower than the predetermined purifying capability.

Next, a second modification of the eighth embodiment will be explained. The configuration of the exhaust purifying system in the present modification may also be the configuration of the exhaust purifying system of the eighth embodiment as shown in FIG. 19 or the configuration of another exhaust purifying system as shown in FIG. 1, etc. In the following description, the explanation will be given by taking as an example a case where the present modification is applied to the ammonia burning internal combustion engine shown in FIG. 1.

Here, in the example shown in FIG. 3, a non-ammonia fuel injector 45 injecting a non-ammonia fuel injects the fuel toward the interior of the intake port. However, it is also possible to arrange the non-ammonia fuel injector so that the ammonia fuel can be directly injected into the combustion chamber 5. When the non-ammonia fuel is injected into the combustion chamber 5 from such a non-ammonia fuel injector in the expansion stroke, the injected non-ammonia fuel burns in the expanding combustion chamber 5, and accordingly the combustion gas in the combustion chamber 5 becomes high in temperature. When the combustion gas becomes high in temperature in this way, the ammonia contained in the combustion gas is oxidized to become nitrogen, and NOₓ contained in the combustion gas reacts with the ammonia and is reduced to nitrogen. Accordingly, by injecting the non-ammonia fuel into the combustion chamber 5 in the expansion stroke, the amounts of NOₓ and ammonia exhausted from the combustion chamber 5 can be reduced.

Therefore, in the present modification, when the purifying capability of the exhaust purifying catalyst 22 has become lower than a predetermined purifying capability (for example, when the temperature of the exhaust purifying catalyst 22 is lower than the predetermined activation temperature), the non-ammonia fuel is injected into the combustion chamber 5 in the expansion stroke. Due to this, the amounts of NOₓ and unburned ammonia exhausted from the combustion chamber 5 are reduced. Therefore, even in a case where the purifying capability of the exhaust purifying catalyst 22 is low, outflow of NOₓ and unburned ammonia in large amounts from the exhaust purifying catalyst 22 can be suppressed.

Next, a third modification of the eighth embodiment will be explained with reference to FIG. 20. The configuration of the ammonia burning internal combustion engine in the present modification is basically the same as the configuration of the ammonia burning internal combustion engine in the above embodiments and above modifications. Explanations of similar configurations will be omitted.

As shown in FIG. 20, in the ammonia burning internal combustion engine of the present modification, an electric heater 66 capable of heating the exhaust purifying catalyst 22 is provided in the exhaust purifying catalyst 22. The electric heater 66 shown in FIG. 20 can directly heat the exhaust purifying catalyst 22. However, an electric heater heating the exhaust gas flowing into the exhaust purifying catalyst 22 and indirectly heating the exhaust purifying catalyst 22 by this exhaust gas may be used in place of this electric heater 66 as well.

In the ammonia burning internal combustion engine of the present modification configured in this way, in a case where the temperature of the exhaust purifying catalyst 22 is lower than the activation temperature thereof, for example at the time of cold start of the engine, the exhaust purifying catalyst 22 is heated and elevated in temperature by the electric heater 66. Due to this, in the case where the temperature of the exhaust purifying catalyst 22 is low, for example at the time of cold start of the internal combustion engine, the exhaust purifying catalyst 22 can be elevated in temperature up to its activation temperature quickly. Accordingly, the period where the temperature of the exhaust purifying catalyst 22 is lower than its activation temperature, that is, the period in which the purifying capability of the exhaust purifying catalyst 22 is low, can be shortened.

Further, in the present modification, during the period where the temperature of the exhaust purifying catalyst 22 is lower than its activation temperature, in addition to heating and temperature elevation of the exhaust purifying catalyst 22 performed by the electric heater 66, as shown in the first modification or second modification described above, the ratio of ammonia in fuel fed into the combustion chamber 5 is lowered, non-ammonia fuel is injected into the combustion chamber 5 in the expansion stroke, or both of those are executed. Due to this, the period in which the temperature of the exhaust purifying catalyst 22 is lower than the predetermined activation temperature can be shortened, and outflow of the unburned ammonia and NOₓ from the exhaust purifying catalyst 22 during the period where the temperature of the exhaust purifying catalyst 22 is lower than the predetermined activation temperature can be suppressed.

Alternatively, in a case where the vehicle mounting the ammonia burning internal combustion engine is a hybrid vehicle driven by an ammonia burning internal combustion engine and a motor (not shown), during the period where the temperature of the exhaust purifying catalyst 22 is lower than the predetermined activation temperature, in addition to the heating and temperature elevation of the exhaust purifying catalyst 22 performed by the electric heater 66, the vehicle is made travel by the motor. Due to this, the period in which the temperature of the exhaust purifying catalyst 22 is lower than the predetermined activation temperature can be shortened. Exhaust gas does not flow into the exhaust purifying catalyst 22 during the period where the temperature of the exhaust purifying catalyst 22 is lower than its activation temperature, accordingly outflow of the unburned ammonia and NOₓ from the exhaust purifying catalyst 22 can be prevented.

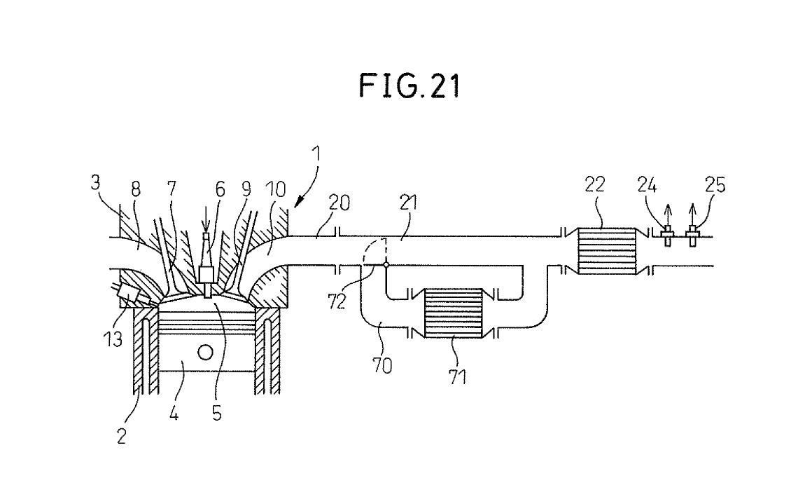

Next, an ammonia burning internal combustion engine of a ninth embodiment of the present invention will be explained with reference to FIG. 21. The configuration of the internal combustion engine of the present embodiment shown in FIG. 21 is basically the same as the configuration of the internal combustion engine of the first embodiment. Explanations of similar configurations will be omitted.

As shown in FIG. 21, the ammonia burning internal combustion engine of the present embodiment is provided with a bypass pipe 70 branched from the exhaust pipe 21, an ammonia adsorbent 71 arranged in the bypass pipe 70, and a flow rate control valve 72 provided in the branch portion from the exhaust pipe 21 to the bypass pipe 70. The bypass pipe 70 merges with the exhaust pipe 21 at an upstream side of the exhaust purifying catalyst 22. Further, the flow rate control valve 72 can control the flow rate of the exhaust gas flowing in the exhaust pipe 21 as it is and the flow rate of the exhaust gas flowing into the bypass pipe 70 (that is, flowing into the ammonia adsorbent 71). The ammonia adsorbent 71 adsorbs the ammonia in the inflowing exhaust gas when the temperature thereof is low and makes the adsorbed ammonia disassociate and releases it when that temperature becomes high. As such an ammonia adsorbent 71, use is made of, for example, the high surface area zeolite, porous ceramic, activated carbon, etc.

In this regard, as explained above, at the time of cold start of the internal combustion engine, the exhaust purifying catalyst 22 is not activated. Accordingly, even when unburned ammonia flows into the exhaust purifying catalyst 22, it cannot be purified in the exhaust purifying catalyst 22. Therefore, in the present embodiment, the flow rate control valve 72 is controlled so that all exhaust gas exhausted from the combustion chamber 5 flows into the ammonia adsorbent 71 when the temperature of the exhaust purifying catalyst 22 is lower than the activation temperature thereof. At this time, the temperature of the ammonia adsorbent 71 is relatively low, therefore the ammonia in the exhaust gas exhausted from the combustion chamber 5 is adsorbed at the ammonia adsorbent 71. Due to this, even at the time of cold start of the internal combustion engine, the ammonia in the exhaust gas can be removed.

After that, after the temperature of the exhaust purifying catalyst 22 becomes the activation temperature thereof or more, the flow rate control valve 72 is controlled so that a portion of the exhaust gas exhausted from the combustion chamber 5 flows into the ammonia adsorbent 71 and the remainder flows through the exhaust pipe 21 as is. Due to this, relatively high temperature exhaust gas will flow into the ammonia adsorbent 71, whereby the temperature of the ammonia adsorbent 71 is raised by the heat of this exhaust gas. In this way, when the temperature of the ammonia adsorbent 71 rises, the ammonia adsorbed at the ammonia adsorbent 71 is made to disassociate. The ammonia disassociated from the ammonia adsorbent 71 is purified by the activated exhaust purifying catalyst 22.

In this way, the ammonia adsorbed at the ammonia adsorbent 71 is gradually made to disassociate. Finally the amount of adsorption of ammonia to the ammonia adsorbent 71 becomes almost zero. In the present embodiment, when the amount of ammonia adsorbed at the ammonia adsorbent 71 becomes almost zero, the flow rate control valve 72 is controlled so that all exhaust gas exhausted from the combustion chamber 5 does not flow into the ammonia adsorbent 71, but flows through the exhaust pipe 21 as it is. Due to this, the high temperature exhaust gas no longer flows into the ammonia adsorbent 71, and accordingly deterioration of the ammonia adsorbent 71 due to heat is suppressed. Further, the amount of ammonia adsorbed at the ammonia adsorbent 71 at this time has become almost zero. Therefore, it becomes possible to adsorb a large amount of ammonia at the ammonia adsorbent 71 when the internal combustion engine is cold started next.

Accordingly, in the present embodiment, the flow rate control valve is controlled so that the exhaust gas exhausted from the engine body flows into the bypass passage at the time of cold start of the internal combustion engine, the flow rate control valve is controlled so that a portion of the exhaust gas exhausted from the engine body flows into the bypass passage after temperature of the exhaust purifying catalyst becomes the activation temperature or more, and the flow rate control valve is controlled so that all of the exhaust gas exhausted from the engine body flows through the engine exhaust passage after the amount of ammonia adsorbed at the ammonia adsorbent is reduced to a certain amount or less.

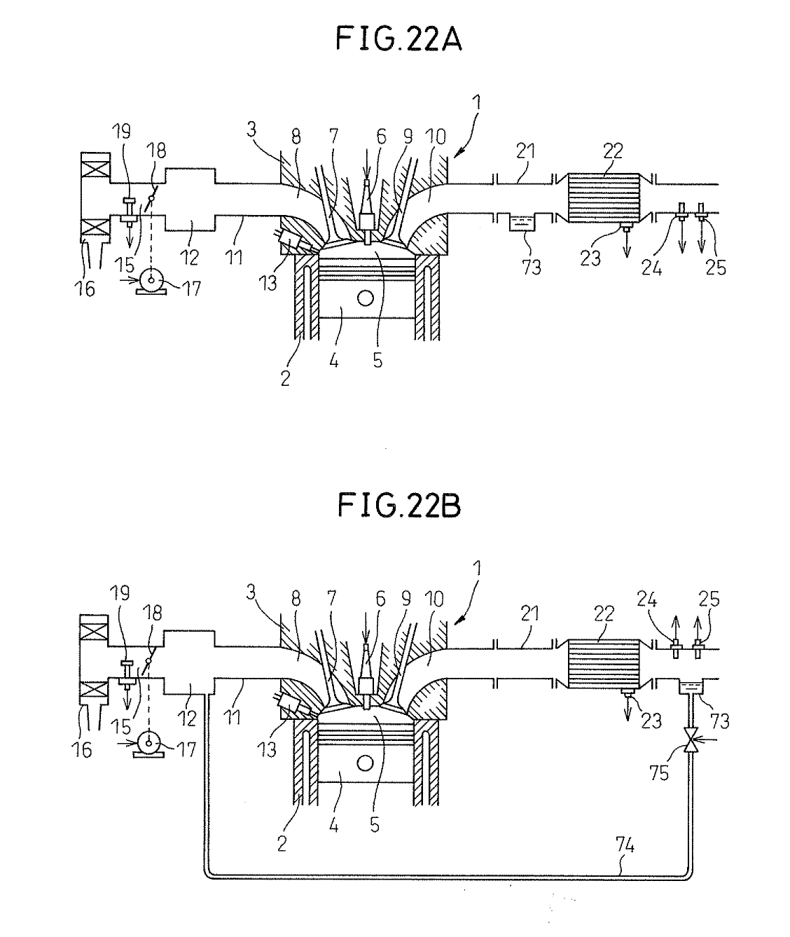

Next, an ammonia burning internal combustion engine of a 10th embodiment of the present invention will be explained with reference to FIGS. 22A and 22B. The configuration of the internal combustion engine of the present embodiment shown in FIGS. 22A and 22B is basically the same as the configuration of the internal combustion engine of the first embodiment. Explanations of similar configurations will be omitted.

As shown in FIG. 22A, the ammonia burning internal combustion engine of the present embodiment is provided with a holder 73 provided in the exhaust pipe 21. The holder 73 is provided at an upstream side of the exhaust purifying catalyst 22. Metal mesh or metal cotton is arranged in the holder 73. The holder 73 is used for storing condensation water condensed from water vapor contained in the exhaust gas.

In the holder 73 configured in this way, at the time when the temperature of the exhaust gas flowing through the exhaust pipe 21 is low such as at the time of cold start of the internal combustion engine, water vapor produced by burning of ammonia in the combustion chamber 5 is condensed in the exhaust pipe 21 and becomes water. The condensation produced in the exhaust pipe 21 in this way flows into the holder 73 and is held in the holder 73. This condensation is held in the holder 73 so as to be exposed to the exhaust gas flowing in the exhaust pipe 21. Further, at the time of the cold start of the internal combustion engine or the like, sometimes unburned ammonia is contained in the exhaust gas exhausted from the combustion chamber 5. In general, ammonia easily dissolves in water, therefore the ammonia contained in the exhaust gas passing above the holder 73 is caught in the condensation held in the holder 73 and held in the holder 73 as ammonia water.

The ammonia water held in the holder 73 is evaporated after warm up of the internal combustion engine (that is after temperature of the exhaust purifying catalyst 22 becomes the activation temperature or more) when the temperature of the exhaust gas flowing in the exhaust pipe 21 becomes high. In this case, first, ammonia in the ammonia water is evaporated, then the water is evaporated after that. The ammonia evaporated in this way is oxidized and/or purified by the exhaust purifying catalyst 22 while the evaporated water is released into the atmosphere as it is.

In this way, according to the present embodiment, by providing the holder for holding the condensation condensed from water vapor contained in the exhaust gas in the engine exhaust passage, by holding water and ammonia in the exhaust gas in the holder at the time of cold start of the internal combustion engine, the ammonia in the exhaust gas can be eliminated. Further, the ammonia held in the holder can be purified by the exhaust purifying catalyst 22 after the temperature of the exhaust purifying catalyst 22 becomes the activation temperature or more.

Next, a modification of the 10th embodiment of the present invention will be explained with reference to FIG. 21B. As shown in FIG. 21B, in the present modification, the holder 73 is provided in the exhaust pipe 21 at a downstream side of the exhaust purifying catalyst 22. Further, the holder 73 is connected to a surge tank 12 through a condensation feed pipe 74. In the condensation feed pipe 74, a shut-off valve 75 capable of shutting off the ammonia water flowing in the condensation feed pipe 74 is provided.

In the holder 73 configured in this way, when the temperature of the exhaust gas flowing through the exhaust pipe 21 is low, in the same way as the above embodiments, water vapor and ammonia in the exhaust gas are caught and held in the holder 73 as the ammonia water.

After that, when warm up of the internal combustion engine is completed and the temperature of the exhaust purifying catalyst 22 becomes the activation temperature or more, the shut-off valve 75 is opened. When the shut-off valve 75 is opened, due to the negative pressure in the surge tank 12, the condensation (ammonia water) stored in the holder 73 is fed into the surge tank 12 through the condensation feed pipe 74. The condensation sucked into the surge tank 12 is fed into the combustion chamber 5 together with the intake gas and burnt.

In this way, according to the present embodiment, by feeding the condensation in the holder 73 into the engine intake passage through the condensation feed pipe 74, it becomes possible to burn the condensation held in the holder 73 in the combustion chamber 5 of the internal combustion engine. Due to this, it becomes possible to arrange the holder 73 at a downstream side of exhaust of the exhaust purifying catalyst 22, and it becomes possible to eliminate the ammonia in the exhaust gas exhausted from the combustion chamber 5.

While the invention has been described with reference to specific embodiments chosen for purpose of illustration, it should be apparent that numerous modifications could be made thereto by those skilled in the art without departing from the basic concept and scope of the invention.

1. An ammonia burning internal combustion engine capable of using ammonia as fuel, comprising an exhaust purifying catalyst purifying ammonia and NOₓ in inflowing exhaust gas and an inflowing gas control system controlling a ratio of ammonia and NOₓ in the exhaust gas flowing into the exhaust purifying catalyst,
wherein the inflowing gas control system controls control parameters of the internal combustion engine so that the ratio of the ammonia and NOₓ in the exhaust gas flowing into the exhaust purifying catalyst becomes a target ratio.

2. An ammonia burning internal combustion engine as set forth in claim 1, wherein the target ratio is made a ratio by which NOₓ in the exhaust gas flowing into the exhaust purifying catalyst is purified exactly enough by ammonia in the exhaust gas.

3. An ammonia burning internal combustion engine as set forth in claim 1, wherein the exhaust purifying catalyst is an NOₓ selective reduction catalyst able to selectively reduce NOₓ in the exhaust gas by adsorbed ammonia, and the target ratio is made a ratio by which the NOₓ becomes larger than a ratio by which NOₓ in the exhaust gas flowing into the NOₓ selective reduction catalyst is purified exactly enough by ammonia in the exhaust gas.

4. An ammonia burning internal combustion engine as set forth in claim 3, wherein the target ratio is made a ratio by which a sum of a maximum amount of ammonia which can be disassociated from the NOₓ selective reduction catalyst per unit time and a flow rate of ammonia in the exhaust gas flowing into the NOₓ selective reduction catalyst becomes smaller than an amount by which exactly enough purifying is carried out by NOₓ in the exhaust gas flowing into the NOₓ selective reduction catalyst.

5. An ammonia burning internal combustion engine as set forth in claim 1, wherein the inflowing gas control system can control the flow rate of NOₓ flowing into the exhaust purifying catalyst, and the flow rate of NOₓ flowing into the exhaust purifying catalyst is controlled to become a flow rate not more than a maximum amount of NOₓ which can be purified per unit time in the exhaust purifying catalyst.

6. An ammonia burning internal combustion engine as set forth in claim 1, wherein a maximum amount of NOₓ which can be purified per unit time in the exhaust purifying catalyst changes in accordance with a temperature of the exhaust purifying catalyst, and the temperature of the exhaust purifying catalyst is controlled so that the flow rate of NOₓ flowing into the exhaust purifying catalyst becomes a flow rate not more than the maximum amount of NOₓ which can be purified per unit time in the exhaust purifying catalyst.

7. An ammonia burning internal combustion engine as set forth in claim 3, wherein when an amount of ammonia adsorbed at the NOₓ selective reduction catalyst becomes smaller than a minimum reference amount, the target ratio is controlled to a ratio by which ammonia becomes larger than a ratio by which NOₓ in the exhaust gas flowing into the NOₓ selective reduction catalyst is purified exactly enough by ammonia in the exhaust gas.

8. An ammonia burning internal combustion engine as set forth in claim 1, wherein the exhaust purifying catalyst is an NOₓ selective reduction catalyst which can selectively reduce NOₓ in the exhaust gas by the adsorbed ammonia, and the target ratio is made a ratio by which ammonia becomes larger than a ratio by which NOₓ in the exhaust gas flowing into the NOₓ selective reduction catalyst is purified exactly enough by ammonia in the exhaust gas.

9. An ammonia burning internal combustion engine as set forth in claim 7, wherein when an amount of ammonia adsorbed at the NOₓ selective reduction catalyst becomes larger than a maximum allowable adsorption amount, the target ratio is changed so that the ratio of ammonia in the exhaust gas flowing into the NOₓ selective reduction catalyst becomes lower.

10. An ammonia burning internal combustion engine as set forth in claim 1, wherein the exhaust purifying catalyst is an NOₓ storage reduction catalyst storing NOₓ in the exhaust gas when an air-fuel ratio of the inflowing exhaust gas is lean and making the stored NOₓ disassociate when an oxygen concentration of the inflowing exhaust gas becomes low, and the target ratio is made a ratio by which NOₓ becomes larger than a ratio by which NOₓ in the exhaust gas flowing into the exhaust purifying catalyst is purified exactly enough by ammonia in the exhaust gas.

11. An ammonia burning internal combustion engine as set forth in claim 10, wherein when the amount of NOₓ stored in the NOₓ storage reduction catalyst becomes larger than a maximum allowable storage amount, the target ratio is controlled to a ratio by which ammonia becomes larger than a ratio by which NOₓ in the exhaust gas flowing into the NOₓ storage reduction catalyst is purified exactly enough by ammonia in the exhaust gas.

12. An ammonia burning internal combustion engine as set forth in claim 1, wherein the inflowing gas control system advances an ignition timing or igniting timing of the air-fuel mixture in a combustion chamber when lowering the ratio of ammonia in the exhaust gas flowing into the exhaust purifying catalyst.

13. An ammonia burning internal combustion engine as set forth in claim 1, wherein the inflowing gas control system lowers the air-fuel ratio of the air-fuel mixture fed into the combustion chamber when raising the ratio of ammonia in the exhaust gas flowing into the exhaust purifying catalyst.

14. An ammonia burning internal combustion engine as set forth in claim 1, further comprising an ammonia injector directly injecting ammonia into a combustion chamber, wherein the inflowing gas control system makes the ammonia injector inject ammonia in an expansion stroke or an exhaust stroke when the ratio of ammonia in the exhaust gas flowing into the exhaust purifying catalyst is made higher.

15. An ammonia burning internal combustion engine as set forth in claim 1, wherein fuel other than ammonia can be used in addition to ammonia, and the inflowing gas control system lowers the ratio of ammonia in the ammonia and fuel other than ammonia which are fed into the combustion chamber when lowering the ratio of ammonia in the exhaust gas flowing into the exhaust purifying catalyst.

16. An ammonia burning internal combustion engine as set forth in claim 1, further comprising a non-ammonia fuel injector capable of directly feeding fuel other than ammonia into a combustion chamber, wherein the inflowing gas control system makes the non-ammonia fuel injector inject the fuel other than ammonia into the combustion chamber in the expansion stroke of the internal combustion engine when lowering the ratio of ammonia in the exhaust gas flowing into the exhaust purifying catalyst.

17. An ammonia burning internal combustion engine as set forth in claim 1, further comprising an oxidation catalyst provided at an upstream side of the exhaust purifying catalyst.

18. An ammonia burning internal combustion engine as set forth in claim 17, wherein the inflowing gas control system is further provided with a bypass passage for bypassing the oxidation catalyst and a flow rate control valve controlling the flow rate of the exhaust gas flowing into the bypass passage, wherein the flow rate control valve is controlled so that the ratio of ammonia and NOₓ in the exhaust gas flowing into the exhaust purifying catalyst becomes the target ratio.

19. An ammonia burning internal combustion engine as set forth in claim 18, wherein the inflowing gas control system increases the flow rate of the exhaust gas flowing into the bypass passage when raising the ratio of ammonia in the exhaust gas flowing into the exhaust purifying catalyst.

20. An ammonia burning internal combustion engine as set forth in claim 17, wherein the inflowing gas control system is further provided with a bypass passage for bypassing the oxidation catalyst and a flow rate control valve controlling the flow rate of the exhaust gas flowing into the bypass passage, wherein the flow rate control valve is controlled so that all exhaust gas flows into the bypass passage when the flow rate of NOₓ in the exhaust gas flowing out of the combustion chamber is larger than the maximum amount of NOₓ which can be purified per unit time.

21. An ammonia burning internal combustion engine as set forth in claim 1, wherein the ammonia burning internal combustion engine is provided with a plurality of cylinders, wherein the air-fuel ratio of the air-fuel mixture is made rich in part of the cylinders among these plurality of cylinders, the air-fuel ratio of the air-fuel mixture is made lean in the other cylinders, and the inflowing gas control system controls a degree of richness and a degree of leanness of these cylinders so that the ratio of ammonia and NOₓ in the exhaust gas flowing into the exhaust purifying catalyst becomes the target ratio.

22. An ammonia burning internal combustion engine as set forth in claim 1, further comprising an ammonia addition device adding ammonia into the exhaust gas flowing into the exhaust purifying catalyst, and the inflowing gas control system increases the added amount of ammonia from the ammonia addition device when raising the ratio of ammonia in the exhaust gas flowing into the exhaust purifying catalyst.

23. An ammonia burning internal combustion engine as set forth in claim 22, wherein the ammonia addition device can add liquid ammonia and gaseous ammonia into the exhaust gas, and liquid ammonia is added into the exhaust gas when the temperature of the exhaust purifying catalyst should be lowered.

24. An ammonia burning internal combustion engine as set forth in claim 1, wherein the internal combustion engine is controlled so that the air-fuel ratio of the air-fuel mixture becomes rich or lean at the time of normal running and controlled so that the air-fuel ratio of the air-fuel mixture becomes substantially the stoichiometric air-fuel ratio when a purifying capability with respect to ammonia and NOₓ of the exhaust purifying catalyst is lower than a predetermined purifying capability.

25. An ammonia burning internal combustion engine as set forth in claim 1, wherein a fuel other than ammonia can be used in addition to ammonia, and the ratio of ammonia in the ammonia and the fuel other than ammonia which are fed into the combustion chamber is made low at the time when the purifying capability with respect to ammonia and NOₓ of the exhaust purifying catalyst is lower than a predetermined purifying capability, in comparison with the time when the former is higher than the predetermined purifying capability.

26. An ammonia burning internal combustion engine as set forth in claim 1, further comprising a non-ammonia fuel injector capable of directly injecting fuel other than ammonia into the combustion chamber, wherein the fuel other than ammonia is injected from the non-ammonia fuel injector into the combustion chamber in the expansion stroke of the internal combustion engine when the purifying capability with respect to ammonia and NOₓ of the exhaust purifying catalyst is lower than the predetermined purifying capability.

27. An ammonia burning internal combustion engine as set forth in claim 1, further comprising an electric heater heating the exhaust purifying catalyst, and the exhaust purifying catalyst is heated by the electric heater when the temperature of the exhaust purifying catalyst is lower than an activation temperature.

28. An ammonia burning internal combustion engine as set forth in claim 27, wherein a vehicle mounting the ammonia burning internal combustion engine is a hybrid vehicle driven by the ammonia burning internal combustion engine and a motor, and the exhaust purifying catalyst is heated by the electric heater and the vehicle is run by the motor when the temperature of the exhaust purifying catalyst is lower than the activation temperature.

29. An ammonia burning internal combustion engine as set forth in claim 1, further comprising a bypass passage branched from an engine exhaust passage, an ammonia adsorbent provided in the bypass passage, and a flow rate control valve controlling the flow rate of the exhaust gas flowing into the engine exhaust passage and the bypass passage, wherein the flow rate control valve is controlled so that the exhaust gas exhausted from the engine body flows into the bypass passage at the time of cold start of the internal combustion engine.

30. An ammonia burning internal combustion engine as set forth in claim 29, wherein the flow rate control valve is controlled so that a portion of the exhaust gas exhausted from the engine body flows into the bypass passage after the temperature of the exhaust purifying catalyst becomes the activation temperature or more, and the flow rate control valve is controlled so that all of the exhaust gas exhausted from the engine body does not flow into the bypass passage, but flows through the engine exhaust passage after the amount of ammonia adsorbed at the ammonia adsorbent is reduced to a constant amount or less.

31. An ammonia burning internal combustion engine as set forth in claim 1, further comprising a holder for holding condensation condensed from water vapor contained in the exhaust gas in the engine exhaust passage, wherein the holder is arranged so that the condensation held in the holder is exposed to the exhaust gas.

32. An ammonia burning internal combustion engine as set forth in claim 31, further comprising a condensation feed passage for connecting the holder and an engine intake passage, wherein the condensation in the holder is fed into the engine intake passage through the condensation feed passage.

33. An ammonia burning internal combustion engine as set forth in claim 1, further comprising an NOₓ sensor having an output value becoming larger when the NOₓ and ammonia in the exhaust gas flowing in the engine exhaust passage increase, wherein control parameters of the internal combustion engine are controlled so that ammonia or NOₓ in the exhaust gas flowing in the engine exhaust passage increases when detecting the flow rate of NOₓ by the NOₓ sensor, and an ingredient detected by the NOₓ sensor is discriminated based on a change of the output value of the NOₓ sensor along with the increase of this ammonia.

34. An ammonia burning internal combustion engine as set forth in claim 1, further comprising an NOₓ detector detecting the concentration of NOₓ in the exhaust gas exhausted from the exhaust purifying catalyst and an ammonia detector detecting the concentration of ammonia in the exhaust gas exhausted from the exhaust purifying catalyst at a downstream side of the exhaust purifying catalyst.
